(19) United States
(12) Patent Application Publication
(10) Pub. No.: US 2019/0387744 A1
(43) Pub. Date: Dec. 26, 2019

(54) Composition and Methods for Reducing Corn-on-Corn Yield Penalty

(71) Applicant: Monsanto Technology LLC, St. Louis, MO (US)

(72) Inventors: Bradon James FABBRI, Chesterfield, MO (US); Ken FERREIRA, Wentzville, MO (US); Janne KEROVUO, St. Louis, MO (US); Matthew McCOWN, Wildwood, MO (US); Radha G. MOHANTY, Ballwin, MO (US); Scott R. SCHAECHER, Webster Groves, MO (US)

(73) Assignee: Monsanto Technology LLC, St. Louis, MO (US)

(21) Appl. No.: 15/777,586

(22) PCT Filed: Nov. 17, 2016
(86) PCT No.: PCT/US16/62535

§ 371 Date: May 18, 2018

Related U.S. Application Data
(60) Provisional application No. 62/258,124, filed on Nov. 20, 2015.

(51) Int. Cl. A01N 63/00; A01C 1/06; A01N 25/26; A01N 43/16

(52) U.S. Cl. CPC A01N 63/00; A01N 43/16; A01N 25/26; A01C 1/06

(57) ABSTRACT

Planting corn in one or more consecutive growing seasons in the same fields causes a yield reduction (“corn-on-corn yield penalty”). We developed methods and compositions comprising a lipo-chitooligosaccharide (LCO), to reduce corn-on-corn yield penalty. The disclosure covers the compositions and methods for reducing corn-on-corn yield penalty.

### FIELD

The present disclosure provides composition and methods for reducing corn-on-corn yield penalty.

### BACKGROUND

Corn is widely cultivated throughout the world, and a greater weight of corn grain is produced each year than any other grain, with the U.S. producing 40%/6 of the world's harvest. Typical yields for soybean, the second most commonly grown crop in the U.S., are only 28 to 34% of corn yields.

The utility of corn is multifaceted. Both grain and stover are used for animal feed and show promise as feedstocks for producing fermentation products. Through traditional or transgenic breeding efforts, corn varieties can be created to adapt to a range of environmental conditions and be resistant to a variety of pests and diseases.

Global demand for corn has grown steadily. Since 1924, corn yield has increased by seven fold with an annual yield growth rate of about 1.5% since 1970, due to improvements in hybrid, greater nitrogen (N) fertilizer rates, and other management practices.

In response to increasing international and domestic demand for U.S. corn grain, consecutive corn planting, namely, planting corn in two or more consecutive growing seasons in the same fields and not rotating with a different crop (“corn-on-corn”), has become a common practice in the U.S. Com-on-corn production accounts for approximately 30% of the total baseline U.S. corn hectares in 2015 and as much as 50%6 of corn hectares in biofuel programs under the Energy Independence and Security Act (EISA) of 2007.

However, there are issues associated with corn-on-corn systems, such as reduced soil biological diversity, potentially causing a reduction in or loss of bio-control services and creating an even greater need for management techniques, including pesticides.

Moreover, it is widely accepted that yields decline in a corn-on-corn system as opposed to when corn is planted in rotation with soybean, wheat, or cotton. Id. This reduction is referred to as the corn-on-corn yield penalty. A 4-year study in eastern Nebraska under rainfed conditions showed that corn yields were 29% greater for corn grown in a 2 year soy-corn rotation than for corn in a continuous corn-on-corn monoculture. See, Peterson and Varvel, Agron. J., 81: 735-738 (1989). In addition, a 16-year study has seen a 22% corn-on-corn yield penalty (compared to corn rotated with soybean) under rainfed conditions. See, Wilhelm and Wortmann, Agron. J., 96: 425-432 (2004).

Reasons for corn-on-corn yield penalty are not fully understood, but weather, corn residue and nitrogen availability are often considered to play a role. See, Ding et al., Can. J. Plant Sci., 78: 29-33 (1998).

The present disclosure describes compositions and methods as effective ways to solve this problem.

### SUMMARY

The present disclosure includes compositions and methods for reducing corn-on-corn yield penalty. The present disclosure further provides that treatment with a lipo-chitooligosaccharide (LCO) results in reduction of corn-on-corn yield penalty. One advantage of an aspect of certain methods disclosed herein is that it provides a composition as an effective means of minimizing impact to yield without crop rotation, i.e. does not require a farmer to plant a second different crop in rotation.

The compositions disclosed herein can be used m combination with other crop management systems.

The present disclosure also provides a method comprising: a) applying a composition comprising a lipo-chitooligosaccharide (LCO) to a population of corn plants or corn seeds in need of reducing a corn-on-corn yield penalty; and b) growing or planting the population of corn plants or corn seeds in need thereof in a field in which corn was grown during a growing season that immediately precedes planting of the population of corn plant or corn seeds in need thereof, where the composition is capable of reducing the corn-on-corn yield penalty.

Further provided by the present disclosure is a method comprising providing to a person a population of corn seeds in need of reducing a corn-on-corn yield penalty and a composition comprising an effective amount of a lipo-chitooligosaccharide (LCO), where the amount is effective for reducing the corn-on-corn yield penalty.

In yet another aspect, the present disclosure includes a method for growing a population of corn plants, comprising selecting a field in which corn was grown during a growing season that immediately precedes selection of the field, planting corn seeds in need of reducing a corn-on-corn yield penalty that have been treated with an effective amount of a lipo-chitooligosaccharide (LCO) in the selected field, where the amount is effective for reducing the corn-on-corn yield penalty.

The present disclosure also provides a method of preventing a corn-on-corn yield penalty in a population of corn plants in need thereof comprising: a) applying a composition comprising an effective amount of a lipo-chitooligosaccharide (LCO) to corn seeds and/or to a field in which corn was grown during a growing season that immediately precedes planting of the corn seeds, and b) planting the corn seeds in the field without growing a population of non-corn plants in the field prior to planting the corn seeds, where the amount is effective to prevent the corn-on-corn yield penalty.

The present disclosure further provides a method of reducing a corn-on-corn yield penalty in a population of corn plants in need thereof comprising a) applying a composition comprising an effective amount of a lipo-chitooligosaccharide (LCO) to corn seeds and/or to a field in which corn was grown during a growing season that immediately precedes planting of the corn seeds; and b) planting the corn seeds in the field without growing a population of non-corn plants in the field prior to planting the corn seeds, where the amount is effective to reduce the corn-on-corn yield penalty.

In a further aspect, the disclosure includes a method of enhancing corn yield in a field grown in a corn-on-corn rotation for two or more consecutive growing seasons, comprising: a) growing a first population of corn plants in the field during a first growing season; and b) growing a second population of corn plants in the field during a second growing season; where the second population of corn plants is treated with a composition comprising a lipo-chitooligosaccharide (LCO) prior to planting, at the time of planting and/or after planting, and where the first and second growing seasons are consecutive growing seasons.

In another aspect, the disclosure includes a method of reducing a corn-on-corn yield penalty in a field grown in a corn-on-corn rotation for two or more consecutive growing seasons, comprising: a) growing a first population of corn plants in the field during a first growing season; and b) growing a second population of corn plants in the field during a second growing season: the second population of corn plants is treated with a composition comprising a lipo-chitooligosaccharide prior to planting, at the time of planting and/or after planting, and where the first and second growing seasons are consecutive growing seasons.

In a further aspect, the present disclosure includes a method of crop rotation management that provides for two consecutive corn plantings in a field where the later planting provides a yield that is at least 80%, 82%, 84%, 86%, 88%, 90%, 92%, 94%, 96%, 98%, 100%, 102%, 104%, 106%, 108%, 110%, 115%, 120%, or 125% of the yield of the earlier planting, the method comprising: a) treating corn seeds with a composition comprising an effective amount of a lipo-chitooligosaccharide (LCO); and b) providing the treated corn seeds to a farmer for growing in a field in which corn was planted in an immediately preceding growing season.

The present disclosure further provides a method of reducing a corn-on-corn yield penalty, the method comprising: a) planting a corn seeds in need thereof that have been treated with a composition comprising a lipo-chitooligosaccharide (LCO) in a field in which corn was grown during a growing season that immediately precedes planting of the corn seeds in need thereof: b) growing corn from the corn seeds in need thereof; and c) producing a yield of corn where the corn-on-corn yield penalty is reduced as a result of the composition comprising a lipo-chitooligosaccharide (LCO).

In another aspect, the present disclosure includes a method of reducing the corn-on-corn yield penalty, the method comprising: a) administering, to a population of corn plants, corn seeds and/or soil containing a population of corn plants or corn seeds in need thereof, a composition comprising an effective amount of a lipo-chitooligosaccharide (LCO); and b) growing the population of corn plants or corn seeds in need thereof in the soil; where corn was grown in the soil during a growing season that immediately precedes growth of the population of corn plant or corn seeds.

In yet another aspect, the present disclosure further includes a method comprising: a) planting corn seeds in soil in which corn was grown during a growing season that immediately precedes planting of the corn seeds; and b) applying a composition comprising a lipo-chitooligosaccharide (LCO) to the soil, to the corn seeds and/or to plants that germinate from the corn seeds, where the composition is capable of increasing the yield of the plants.

Yet another aspect of the present disclosure includes a method of maximizing a field's farming revenue, the method comprising: a) determining a first projected net revenue from consecutive plantings of corn for at least two growing seasons in the field; b) determining a second projected net revenue from a corn on non-corn rotation in the field for the same number of growing seasons; c) determining a third projected net revenue from consecutive plantings of corn for at least two growing seasons in the field, where the third projected net revenue assumes that the corn and/or the field will be treated with a composition capable of reducing a corn-on-corn yield penalty in the field; d) comparing the first, second and third projected net revenues: e) recommending consecutive corn plantings; and f) providing corn seeds that have been treated with a composition comprising an effective amount of a lipo-chitooligosaccharide (LCO).

In another aspect, the present disclosure includes a method comprising a) providing a farmer in need thereof with instructions for reducing a corn-on-corn yield penalty by applying an effective amount of LCO to a corn seed or to plants growing from the corn seed; and b) providing to the farmer a composition comprising an effective amount of LCO for reducing the corn-on-corn yield penalty.

### DESCRIPTION OF DRAWINGS

FIG. 1: Relationship between years in continuous corn and the continuous corn yield penalty. Adapted from Gentry et al., 2013.

### DETAILED DESCRIPTION

Unless defined otherwise, technical and scientific terms as used herein have the same meaning as commonly understood by one of ordinary skill in the art. One skilled in the art will recognize many methods can be used in the practice of the present disclosure. Indeed, the present disclosure is in no way limited to the methods and materials described. Any references cited herein are incorporated by reference in their entireties. Singular forms “a,” “an,” and “the” are intended to include the plural forms as well, unless the context indicates otherwise.

As used herein, “a population” means at least 100 plants, 200 plants, 500 plants, 1000 plants, 5000 plants, 10,000 plants, 50,000 plants, 100,000 plants, or more. In an aspect, a population of corn plants can be planted at least 1000 plants/acre, 5000 plants/acre, 10,000 plants/acre, 20,000 plants/acre, 50,000 plants/acre, 100,000 plants/acre, or more. In another aspect, a population of soybean plants can be planted at least 10,000 plants/acre, 20,000 plants/acre, 50,000 plants/acre, 100,000 plants/acre, 200,000 plants/acre, or more. In one aspect, a population of wheat plants can be planted at least 500,000 plants/acre. In further aspect, a population of cotton can be planted at least 50,000 plants/acre. A person of ordinary skill in the art would understand the planting density for the plants referenced in the present disclosure.

As used herein. “a plant” means a population of plants grown in a field that produces a crop.

As used herein, “a population of corn seeds” may contain any number, weight or volume of corn seeds. For example, a population can contain at least, or greater than, about 10, 25, 50, 75, 100, 200, 300, 400, 500, 600, 700, 800, 900, 1000, 1500, 2000, 2500, 3000, 3500, 4000, 4500, 5000 or more corn seeds. Alternatively, the population can contain at least, or greater than, about 1 ounce, 5 ounces, 10, ounces, 1 pound, 2 pounds, 3 pounds, 4 pounds, 5 pounds, or more corn seeds. In one aspect, the population can contain at least 5 pounds, 10 pounds, 25 pounds, 50 pounds, 100 pounds, or more corn seeds. The present disclosure also provides a population of corn seeds with the composition comprising a lipo-chitooligosaccharide (LCO) in which at least 10%, 20%, 30%, 40%, 50%, 60%, 70%, 80%, 90%, or 100% of the seeds are provided with the composition.

Populations of corn seeds may be in any container available in the art. As used herein. “a container of corn seeds” may contain any number, weight or volume of corn seeds. For example, a container can contain at least, or greater than, about 10, 25, 50, 75, 100, 200, 300, 400, 500, 600, 700, 800, 900, 1000, 1500, 2000, 2500, 3000, 3500, 4000, 4500, 5000 or more corn seeds. Alternatively, the container can contain at least, or greater than, about 1 ounce, 5 ounces, 10, ounces, 1 pound, 2 pounds, 3 pounds, 4 pounds, 5 pounds, or more corn seeds. In one aspect, the container can contain at least 5 pounds, 10 pounds, 25 pounds, 50 pounds, 100 pounds, or more corn seeds. The present disclosure also provides a container of corn seeds with the composition comprising Penicillium bilaii in which at least 10%, 20%, 30%, 40%, 50%, 60%, 70%, 80%, 90%, or 100% of the seeds are provided with the composition. Containers of corn seeds may be any container available in the art.

The present disclosure provides a method comprising: a) applying a composition comprising a lipo-chitooligosaccharide (LCO) to a population of corn plants or corn seeds in need of reducing a corn-on-corn yield penalty; and b) growing or planting the population of corn plants or corn seeds in need thereof in a field in which corn was grow during a growing season that immediately precedes planting of the population of corn plant or corn seeds in need thereof, where the composition is capable of reducing the corn-on-corn yield penalty.

In another aspect a composition comprises a lipo-chitooligosaccharide (LCO). In one aspect a population of corn plants or part thereof is provided in a composition comprising a lipo-chitooligosaccharide (LCO). In one aspect, a lipo-chitooligosaccharide (LCO) can be any lipo-chitooligosaccharide (LCO).

In one aspect, a composition comprises a lipo-chitooligosaccharide but lacks a chitooligosaccharide.

In an aspect, a LCO is synthetic.

In an aspect, the LCO is present in a composition in an amount from about 10⁻⁵ to about 10⁻¹⁴ M.

In an aspect, the LCO present in a composition is at a concentration of at least about 10⁻⁵ Molar, at least about 10⁻⁶ Molar, at least about 10⁻⁷ Molar, at least about 10⁻⁸ Molar, at least about 10⁻⁹ Molar, at least about 10⁻¹⁰ Molar, at least about 10⁻¹¹ Molar, at least about 10⁻¹² Molar, at least about 10⁻¹³ Molar, or at least about 10⁻¹⁴ Molar. In an aspect, the LCO is at a concentration from about 10⁻⁵ to about 10⁻¹⁴ Molar, from about 10⁻⁶ to about 10⁻¹⁴ Molar, from about 10⁻⁷ to about 10⁻¹⁴ Molar, from about 10⁻⁸ to about 10⁻¹⁴ Molar, from about 10⁻⁹ to about 10⁻¹⁴ Molar, from about 10⁻¹⁰ to about 10⁻¹⁴ Molar, from about 10⁻¹¹ to about 10⁻¹⁴ Molar, from about 10⁻¹² to about 10⁻¹⁴ Molar, or from about 10⁻¹³ to about 10⁻¹⁴ Molar.

In another aspect, the LCO is present in an amount from 1×10¹ to 1×10¹⁵ cfu/seed.

In an aspect, effective amount of a composition comprising lipo-chitooligosaccharide (LCO) is sufficient to cause a reduction of corn-on-corn yield penalty or other desired agricultural trait. The actual effective amount in absolute value depends on factors including, but not limited to, the size (e.g., the area, the total acreage, etc.) of the land for application with lipo-chitooligosaccharide (LCO), synergistic or antagonistic interactions between other active or inert ingredients.

Without being limited by any theory, lipo-chitooligosaccharides (LCOs) can in one aspect, activate symbiotic and developmental genes which results in a change in the root architecture or physiology of the plant. In another aspect, LCOs drive the natural growth processes, which enhance crop performance.

In an aspect, the composition does not include a functional level of a phosphate solubilizing microorganism. In an aspect, the composition does not include a phosphate solubilizing microorganism from the Penicillium genus. In an aspect, the composition does not include a detectable level of Penicillium bilaii. As used herein, the term Penicillium bilaii is intended to include all iterations of the species name, such as “Penicillium bilaiae” and “Penicillium bilaji.”

Lipo-chitooligosaccharides (LCOs) included in the compositions and methods of the present disclosure provided include those, without limitation, that can be isolated, derived or obtained from any suitable non-natural source, including synthetic and partially synthetic, natural source or any combination thereof. Lipo-chitooligosaccharides (LCOs), for use in combination with a method or composition can be any LCO and are sometimes referred to as symbiotic nodulation (Nod) signals or Nod factors. LCO include those with an oligosaccharide backbone of β-1,4-linked N-acetyl-D-glucosamine (“GlcNAc”) residues with an N-linked fatty acyl chain condensed at the non-reducing end. LCOs differ in the number of GlcNAc residues in the backbone, in the length and degree of saturation of the fatty acyl chain, and in the substitutions of reducing and non-reducing sugar residues. See. e.g., Denarie, et al., Ann. Rev. Biochem. 65:503 (1996); Hamel, et al., Planta 232:787 (2010); Prome, et al., Pure & Appl. Chem. 70(1):55 (1998).

In one aspect, compositions of the present disclosure comprise one or more LCOs represented by formula I:

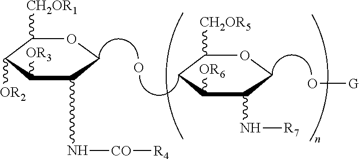

in which G is a hexosamine which can be substituted, for example, by an acetyl group on the nitrogen, a sulfate group, an acetyl group and/or an ether group on an oxygen; R₁, R₂, R₃, R₅, R₆ and R₇, which may be identical or different, represent H, CH₃ CO—, CₓH_{y}CO— where x is an integer between 0 and 17, and y is an integer between 1 and 35, or any other acyl group such as, for example, a carbamoyl; R₄ represents a saturated or mono-, di- or tri-unsaturated aliphatic chain containing at least 12 carbon atoms; and n is an integer between 1 and 4.

LCOs can be obtained (i.e., isolated and/or purified) from bacteria and fungi or via a laboratory.

As will be understood by those skilled in the art, a given bacterial/fungal strain can produce multiple LCOs. For example, and in one aspect, LCOs of the present disclosure include those produced by strains of S. meliloti, represented, in one aspect by formula II:

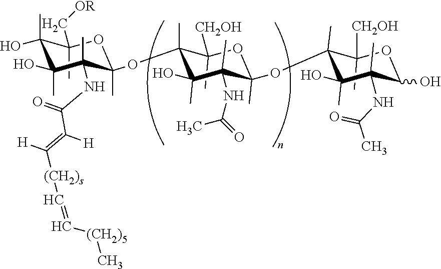

in which R represents H or CH₃CO— and n is equal to 2 or 3. See, e.g., U.S. Pat. No. 5,549,718. A number of Bradyrhizobium japonicum-derived LCOs have also been described including BjNod-V (C_{18.1}), BjNod-V (A_{C}, C_{18:1}), BjNod-V (C_{16:1}), and BjNod-V (A_{C}, C_{16:0}) (with “V” indicating the presence of five N-acetylglucosamines, “Ac” an acetylation, the number following the “C” indicating the number of carbons in the fatty acid side chain, and the number following the “:” indicating the number of double bonds). See, e.g., U.S. Pat. Nos. 5,175,149 and 5,321,011. Additional, non-limiting, LCOs can be obtained from bacterial strains including NodRM, NodRM-1, NodRM-3. When acetylated (the R═CH₃CO—), they become AcNodRM-1, and AcNodRM-3, respectively (U.S. Pat. No. 5,545,718). Representative fungal-derived LCOs and derivatives thereof are represented by formula III:

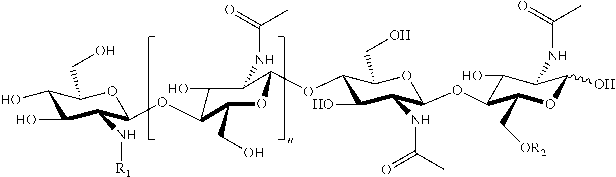

in which n=1 or 2; R₁ represents C16, C16:0, C16:1, C16:2, C18:0, C18:1Δ9Z or C18:1Δ11Z; and R represents hydrogen or SO₃H.

In an aspect the LCO is obtained (i.e., isolated and/or purified) from a bacterial strain. For example, in an aspect, compositions of the present disclosure comprise one or more LCOs obtained from a strain of Azorhizobium, Bradyrhizobium (e.g., B. japonicum), Mesorhizobium, Rhizobium (e.g., R. leguminosarum), or Sinorhizobium (e.g., S. meliloti).

In an aspect, the LCO is obtained (i.e., isolated and/or purified) from a mycorrhizal fungus. For example, in an aspect, compositions of the present disclosure comprise one or more LCOs obtained from a strain of Glomerocycota (e.g., Glomus intraradicus). See. e.g., WO 2010/049751 (in which the LCOs are referred to as “Myc factors”).

In an aspect, the LCO is synthetic. For example, in an aspect, compositions of the present disclosure comprise one or more of the synthetic LCOs described in WO 2005/063784, WO 2007/117500, and/or WO 2008/071674. In an aspect, a synthetic LCO can have the basic structure of a LCO but contains one or more modifications or substitutions, including, without limitation, those described in Spaink, Crit. Rev. Plant Sci. 54:257 (2000) and D'Haeze, supra.

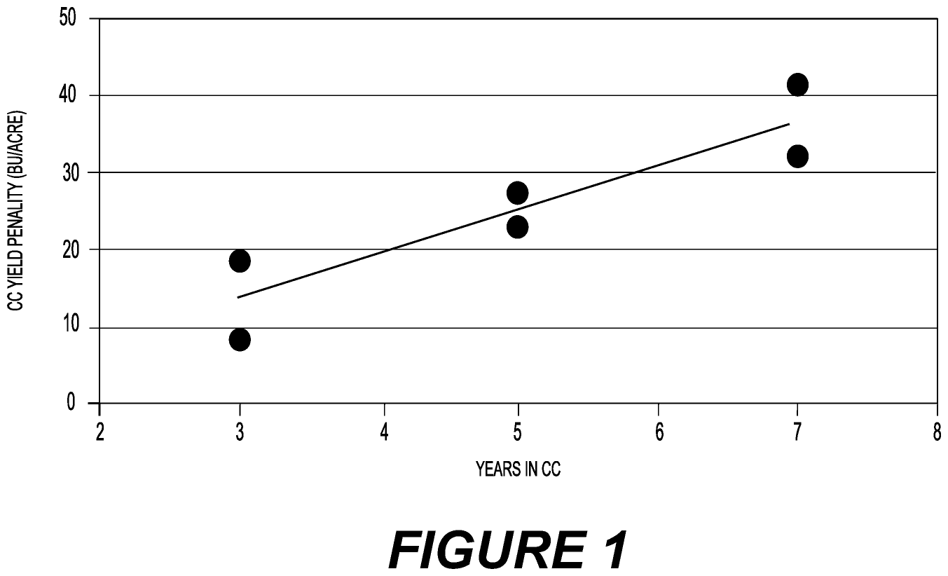

LCOs can be synthesized by genetically engineered organisms. See, e.g., Samain et al., Carbohydrate Res. 302:35 (1997); Cottaz, et al, Meth. Eng. 7(4):311 (2005); and Samain et al., J. Biotechnol. 72:33 (1999) (e.g., FIG. 1 therein, which shows structures of COs that can be made recombinantly in E. coli harboring different combinations of genes nodBCHL).

Further examples of lipo-chitooligosaccharides (and derivatives thereof) that can be used in compositions and methods of the present disclosure include those provided below as formula IV:

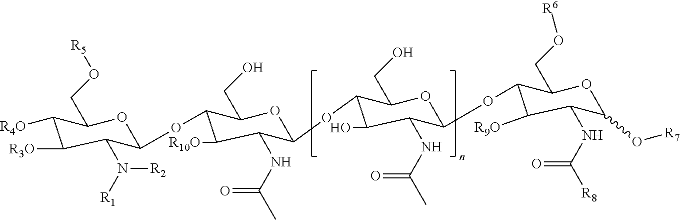

in which R₁ represents C14:0, 30H—C14:0, iso-C15:0, C16:0, 3-OH—C16:0, iso-C15:0, C16:1, C16:2, C16:3, iso-C17:0, iso-C17:1, C18:0, 30H—C18:0, C18:0/3-OH, C18:1, OH—C18:1, C18:2, C18:3, C18:4, C19:1 carbamoyl, C20:0, C20:1, 3-OH—C20:1, C20:1/3-OH, C20:2, C20:3, C22:1, and C18-26(ω-1)-OH (which according to D'Haeze, et al., Glycobiology 12:79R-105R (2002), includes C18, C20, C22, C24 and C26 hydroxylated species and C16:1Δ9, C16:2 (Δ2,9) and C16:3 (Δ2,4,9)); R₂ represents hydrogen or methyl; R₃ represents hydrogen, acetyl or carbamoyl; R₄ represents hydrogen, acetyl or carbamoyl; R₅ represents hydrogen, acetyl or carbamoyl; R₆ represents hydrogen, arabinosyl, fucosyl, acetyl, SO₃H, sulfate ester, 3-0-S-2-0-MeFuc, 2-0-MeFuc, and 4-0-AcFuc; R₇ represents hydrogen, mannosyl or glycerol; R₈ represents hydrogen, methyl, or —CH₂OH; R₉ represents hydrogen, arabinosyl, or fucosyl; R₁₀ represents hydrogen, acetyl or fucosyl; and n represents 0, 1, 2 or 3.

Further examples of lipo-chitooligosaccharides (and derivatives thereof) that can be useful in compositions and methods of the present disclosure are provided below as structures V-XXXIII:

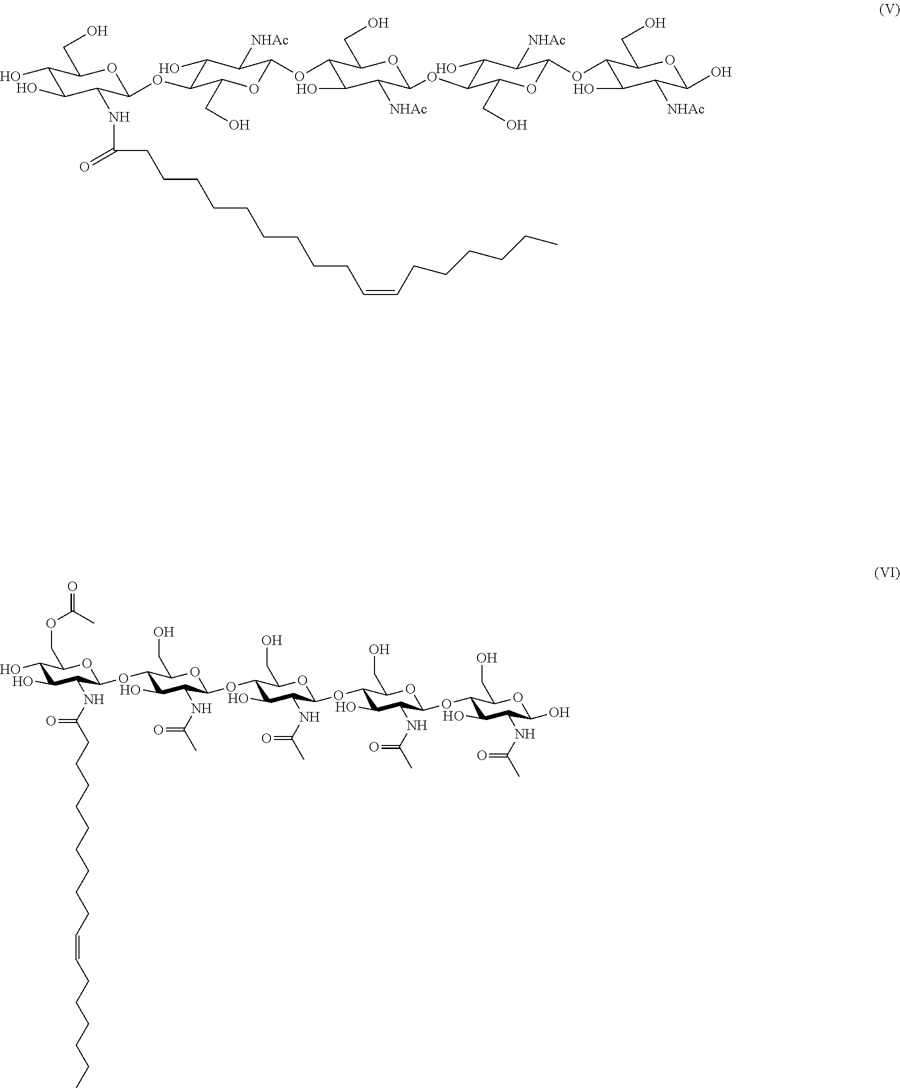

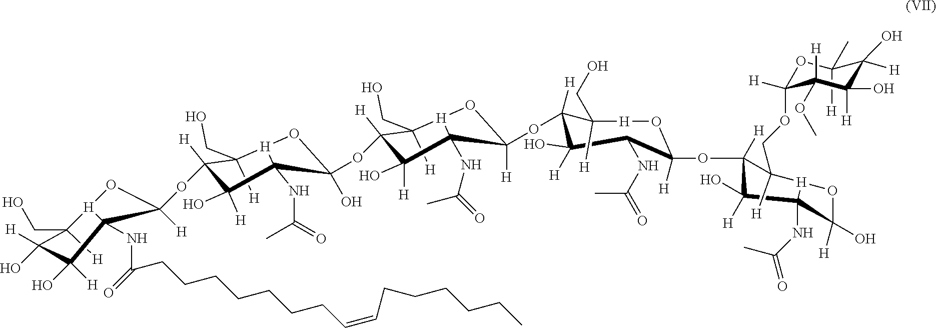

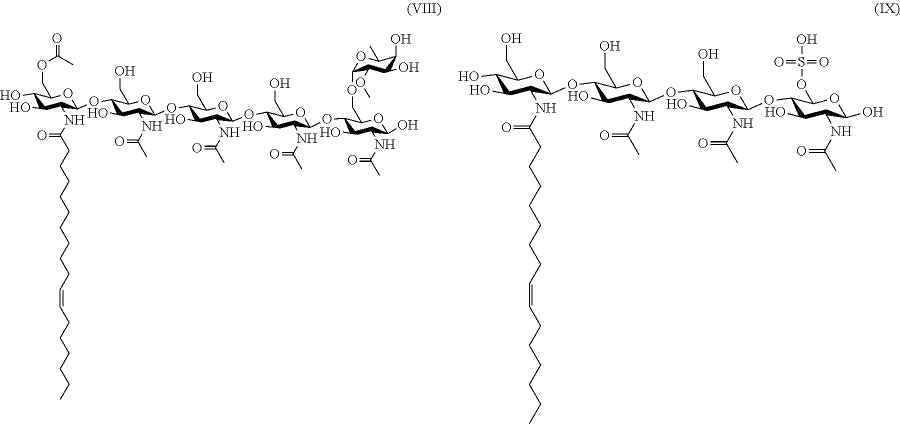

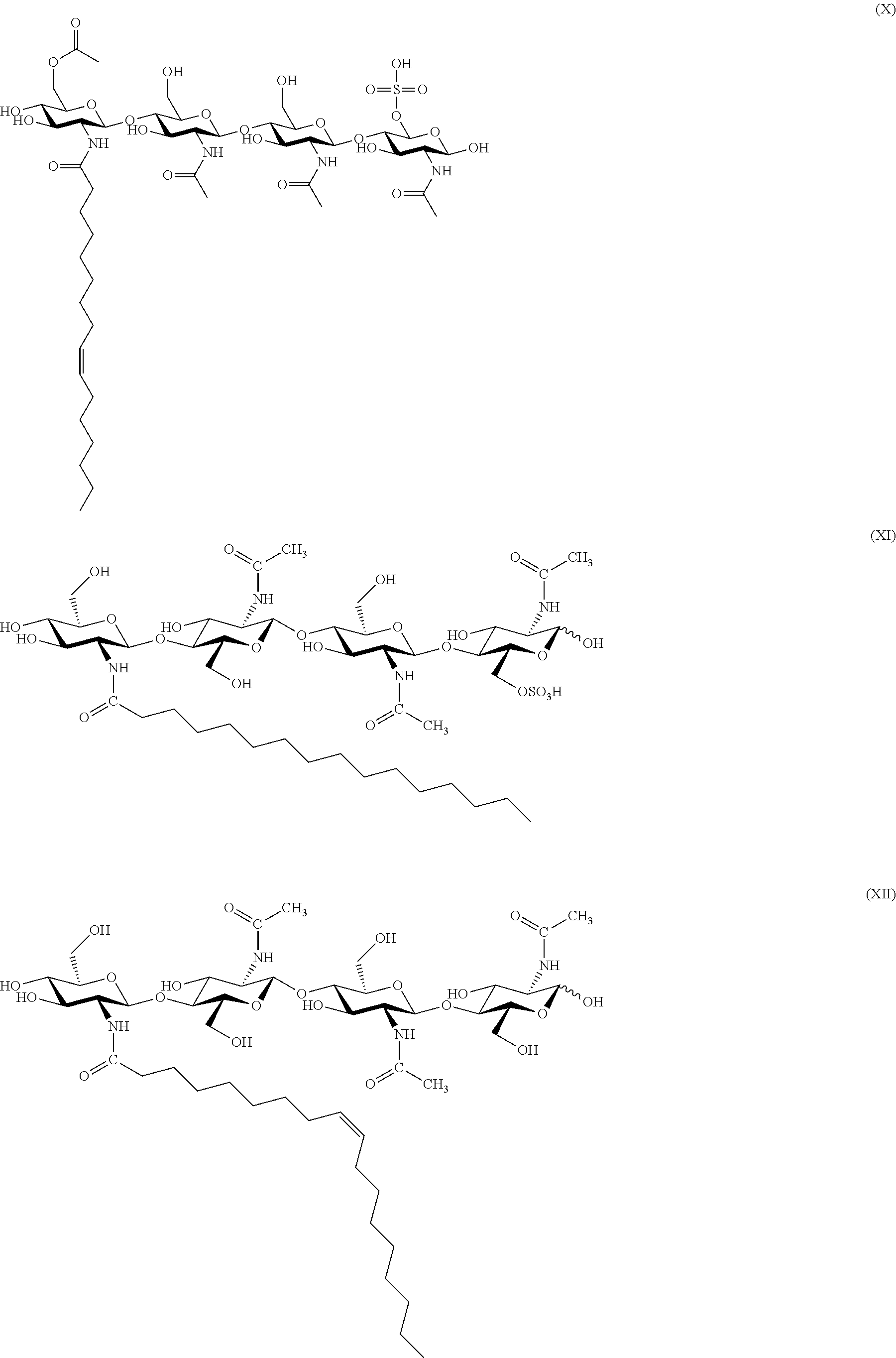

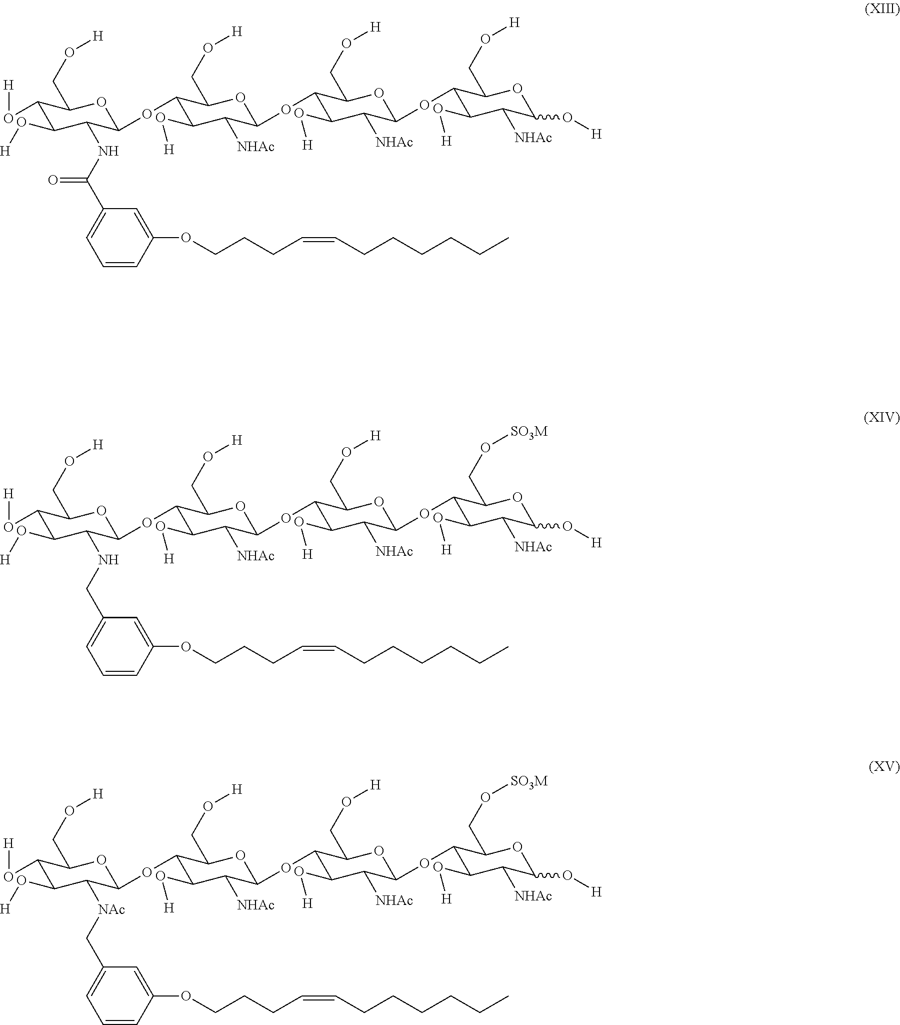

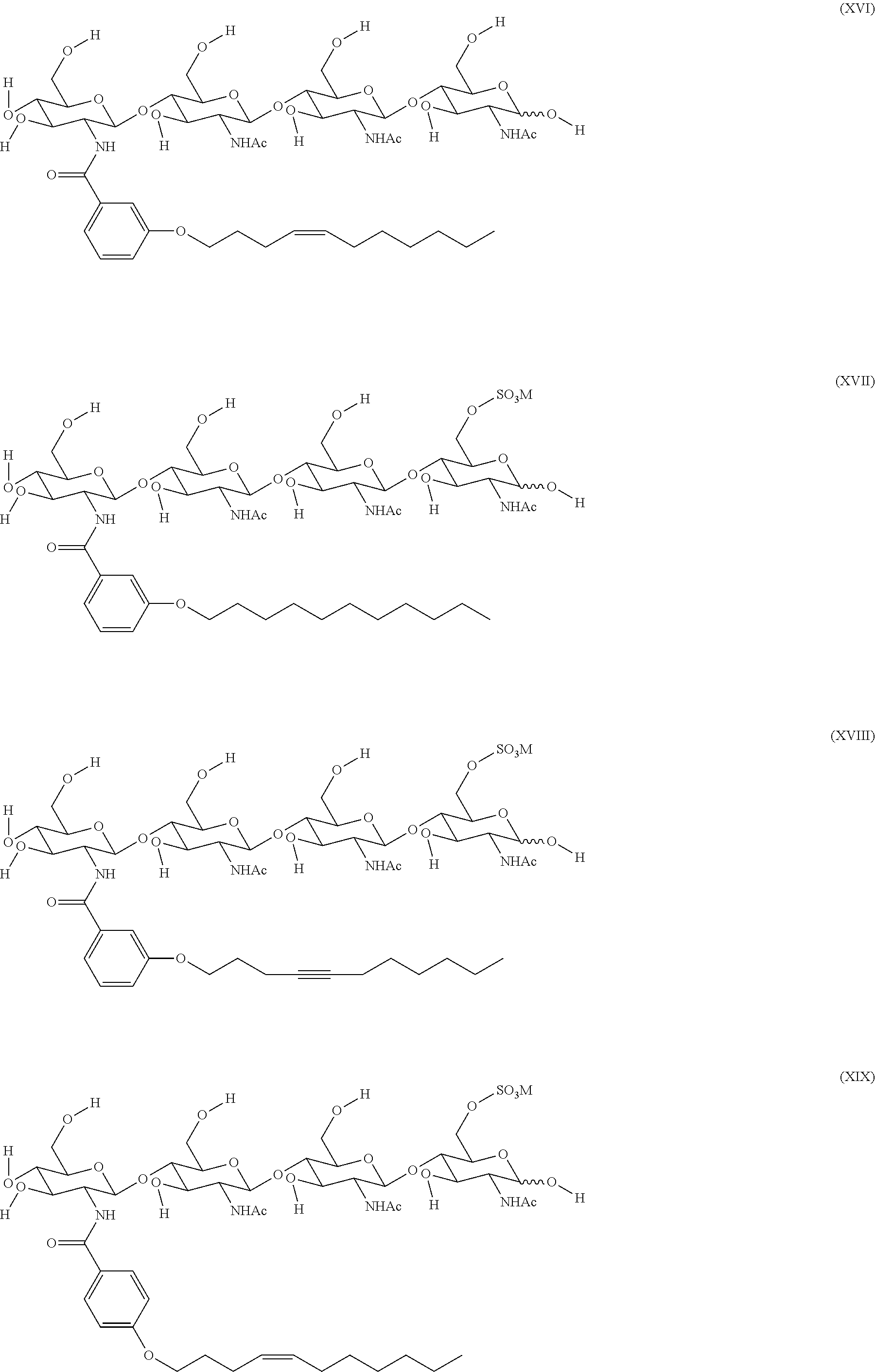

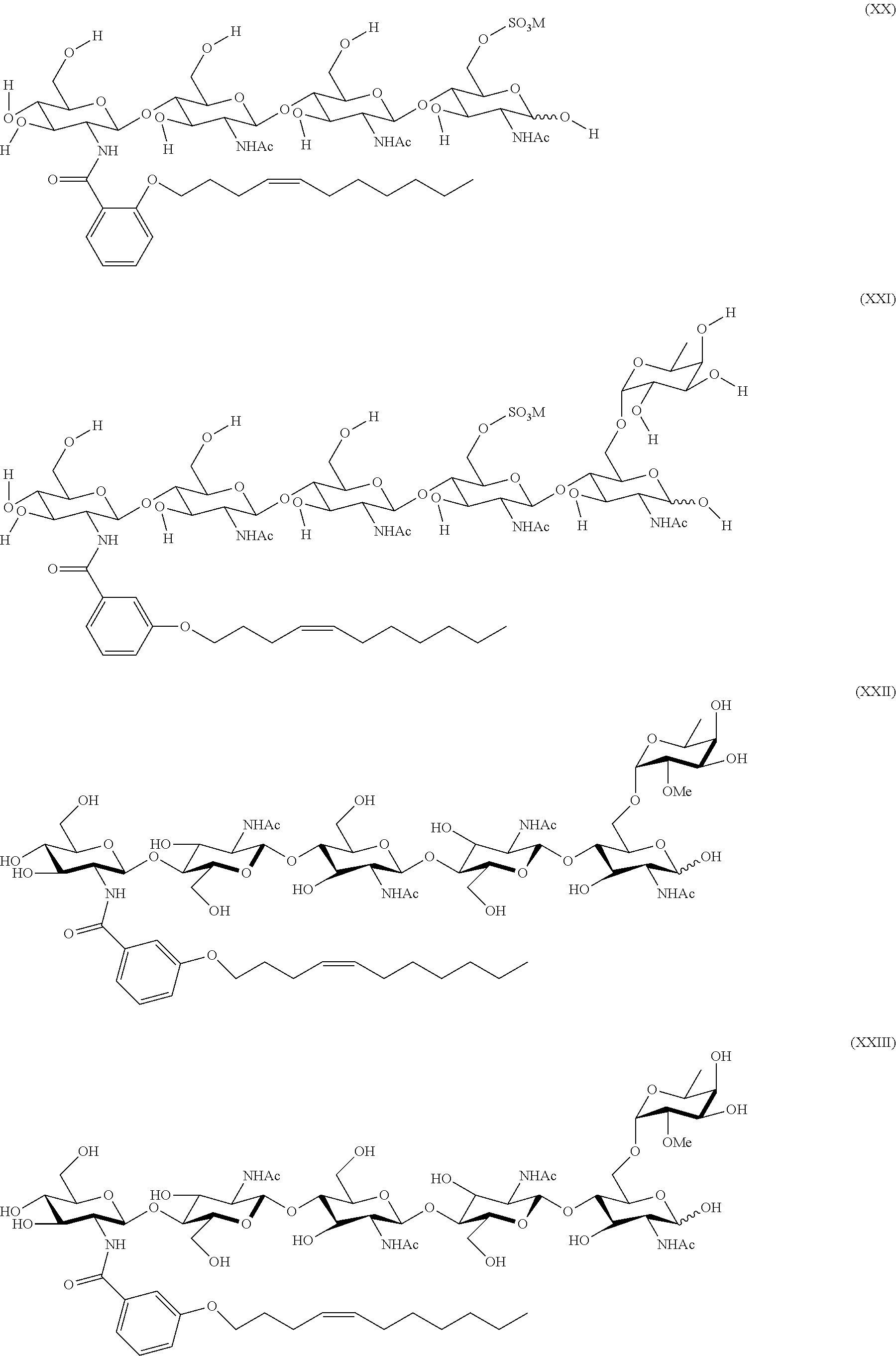

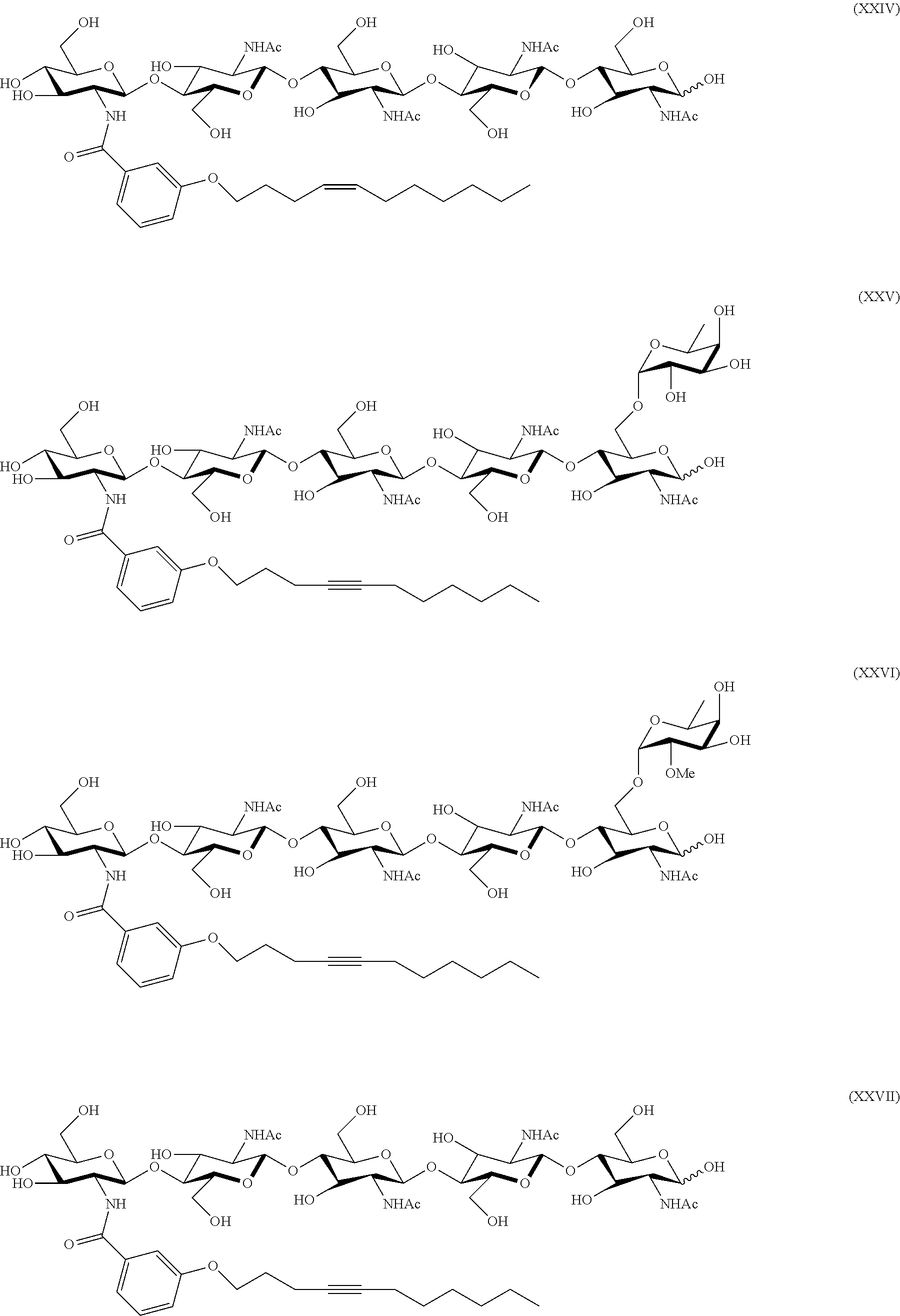

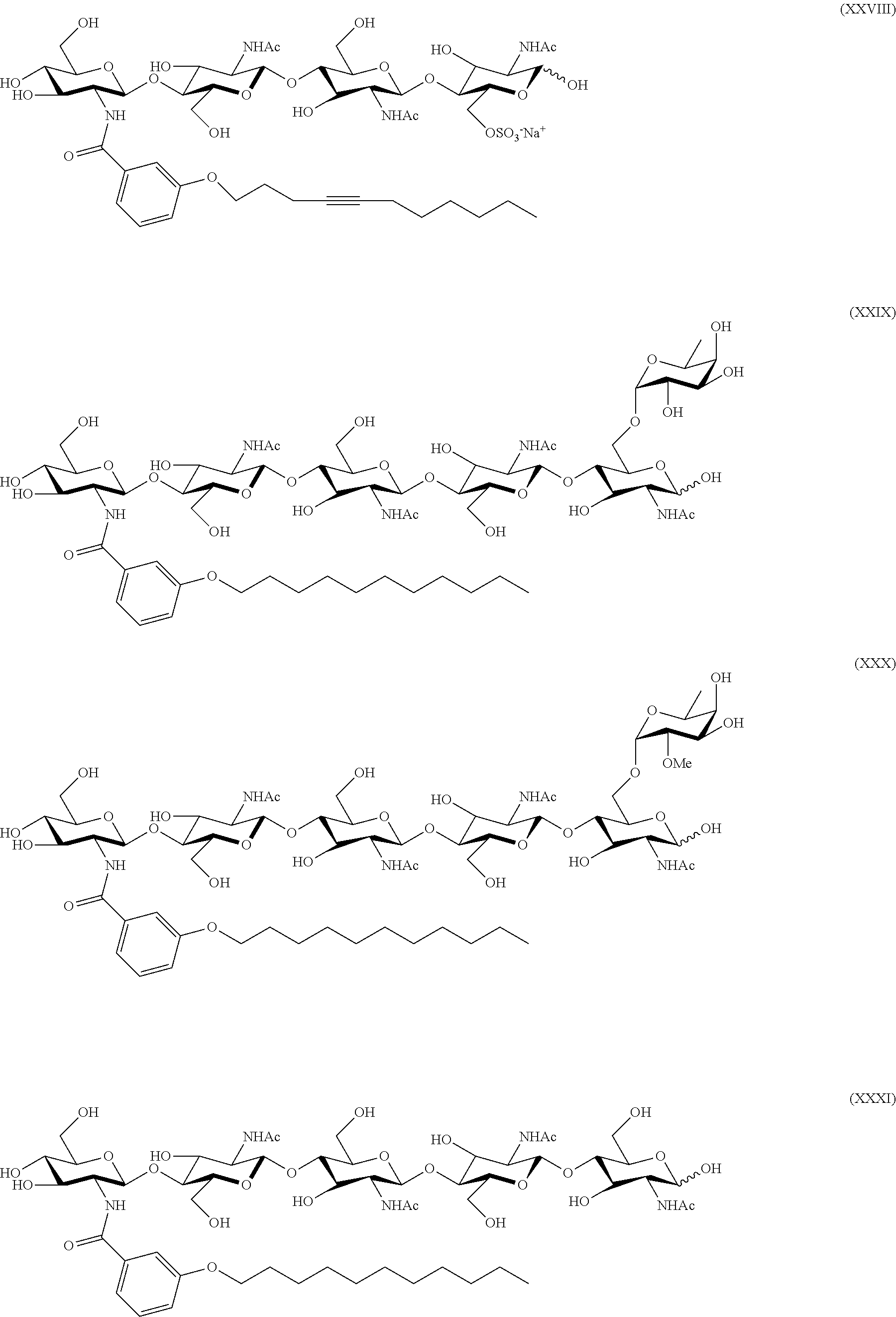

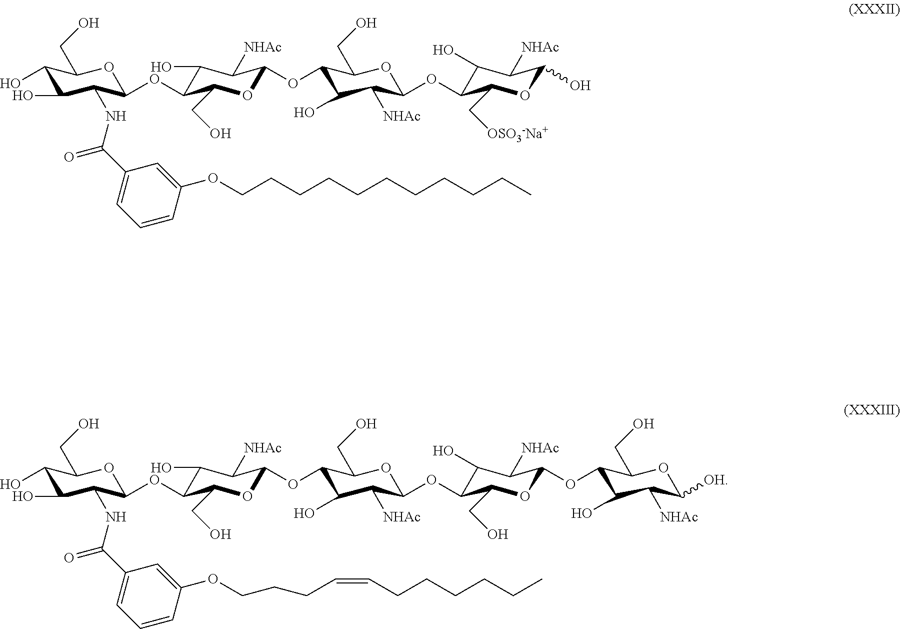

LCOs (and derivatives thereof) can be utilized in various forms of purity and can be used alone or in the form of a culture of LCO-producing bacteria or fungi. For example, OPTIMIZE® (commercially available from Novozymes BioAg Inc.) contains B. japonicum and LCO (including but not limited to LCO-V (C18:1, MeFuc), MOR116). Methods to provide substantially pure LCOs include removing the microbial cells from a mixture of LCOs and the microbe, or continuing to isolate and purify the LCO molecules through LCO solvent phase separation followed by HPLC chromatography as described, for example, in U.S. Pat. No. 5,549,718. Purification can be enhanced by repeated HPLC, and the purified LCO molecules can be freeze-dried for long term storage. LCO can be purified or synthesized and provided to any composition in a pure or semi-pure form. In one aspect an LCO is provided in a form at least 20% pure, at least 30% pure, at least 40% pure, at least 50% pure, at least 60% pure, at least 65% pure, at least 70% pure, at least 75% pure, at least 80% pure, at least 85% pure, at least 90% pure, at least 91% pure, at least 92% pure, at least 93% pure, at least 94% pure, at least 95% pure, at least 96% pure, at least 97% pure, at least 98% pure, at least 99% pure, up to 100% pure.

It is to be understood that compositions and methods of the present disclosure can comprise analogues, derivatives, hydrates, isomers, salts, and/or solvates of LCOs.

In one aspect, compositions of the present disclosure comprise one, two, three, four, five, six, seven, eight, nine, ten, or more LCOs.

In one aspect, the LCOs, can be represented by one or more of formulas I-IV and/or structures V-XXXIII and/or one, two, three, four, five, six, seven, eight, nine, ten, or more analogues, derivatives, hydrates, isomers, salts, and/or solvates of LCOs represented by one or more of formulas I-IV and/or structures V-XXXTII.

In an aspect, the LCO is obtained from a microorganism selected from the group consisting of bacteria from the genera Rhzobium (e.g., R. cellulosilyticum, R. daejeonense, R. etli, R. galegae, R. gallicum, R. giardinii, R. hainanense, R. huautlense, R. indigoferae, R. leguminosarum, R. loessense, R. lupini, R. lusitanum, R. meliloti, R. mongolense, R. miluonense, R. sullae, R. tropici, R. undicola, and/or R. yanglingense), Bradyrhizobium (e.g., B. bete, B. canariense, B. elkanii, B. iriomotense, B. japonicum, B. jicamae, B. liaoningense, B. pachyrhizi, and/or B. yuanmingense), Sinorhizobium (e.g., S. abri, S. adhaerens, S. americanum, S. aboris, S. fredii, S. indiaense, S. kostiense, S. kummerowiae, S. medicae, S. meliloti. S. mexicanus, S. morelense, S. saheli, S. terangae, and/or S. xinjiangense), and Azorhizobium (e.g., A. caulinodans and/or A. doebereinerae). In an aspect, the LCO is from a mycorrhizal fungus.

In one aspect, a population of corn plants or corn seeds is provided in a composition. In one aspect, the composition is provided as a seed coating. In another aspect, the composition is provided to a planted seed, for example, in soil. In another aspect, the composition is provided to a green, above ground tissue, of a plant. In another aspect, one or more compositions are applied to both the seed and a green tissue. In another aspect, different compositions are applied to green tissue and seeds of the same plant. Such applications can be at similar times or growth stages or at different growth stages or times. Such applications can be timed to match environmental conditions.

In another aspect, the composition is applied to the corn seeds prior to planting. In another aspect the composition is applied to the soil prior to planting. In another aspect, the composition is applied to the corn seeds at planting. In an aspect, the composition is provided to the corn seeds prior to the planting. In an aspect, the composition is applied to the soil prior to development stage V1. In an aspect, the composition is applied to the foliage of corn plants germinating from the corn seeds prior to development stage V1.

In an aspect, the applying of the composition is selected from the group consisting of coating the corn seeds with the composition prior to planting, applying the composition to the soil of the field prior to planting, applying the composition to the soil of the field at planting, applying the composition to the soil after planting, and applying the composition to the foliage of a population of corn plants growing in the field. In an aspect, the applying is applying the composition in-furrow. In an aspect, the applying is applying the composition to the population of corn seeds as a seed coating.

In one aspect the applying of any composition or method step can be performed in its entirety by a farmer, a farm worker, a laborer, a seed distributor, an agrochemical company, an agricultural technology company, or any other parties similarly situated.

In an aspect any seed or plant can be treated or used. In one aspect the seed is a corn seed and the plant is a corn plant. In one aspect, corn includes Zea mays or maize and includes all plant varieties that can be bred with corn. In another aspect a corn plant is a commercial plant available to farmers. In another aspect, a corn plant or seed can be an elite seed or plant. In another aspect, a corn plant can be a hybrid. In a further aspect a corn plant can be an inbred.

In one aspect, any appropriate plant part can be treated or used including plant organs (e.g., leaves, stems, roots, etc.), seeds, and plant cells and progeny of the same.

In another aspect, a composition can be in the form of a seed coating. Any appropriate seed coating can be used. In one aspect, liquid, slurry, or powder (e.g., wettable powder) form can be suitable for coating seeds. In one aspect, when used to coat seeds, the composition can be applied to the seeds and allowed to dry. In an aspect where the composition is a powder (e.g., a wettable powder), a liquid, such as water, can be added to the powder before application to a seed.

In another aspect, a treatment entails coating seeds with the at least two, three, four, five, or more compositions. One illustrative process involves coating the inside wall of a round container with the composition, adding seeds, then rotating the container to cause the seeds to contact the wall and the composition, a process known in the art as “container coating.” Seeds can be coated by combinations of coating methods. Soaking typically entails use of an aqueous solution containing the plant growth enhancing agent. For example, seeds can be soaked for about 1 minute to about 24 hours (e.g., for at least 1 min, 5 min, 10 min, 20 min, 40 min, 80 min, 3 hr, 6 hr, 12 hr, or 24 hr). In one aspect, soaking is typically carried out for about 1 minute to about 20 minutes.

In one aspect seeds can be stored after application. In one aspect, the effectiveness of the seed coating can be retained for at least 50, 60, 70, 80, 90%, or more 6 months after the coating of the seeds with the composition.

In one aspect a composition, including those comprising LCOs is capable of diffusing toward a young developing radical.

In one aspect, compositions containing the LCOs can further contain a sticking or coating agent. In one aspect, compositions can further contain a coating polymer and/or a colorant.

In one aspect, at least two different compositions are applied to seeds (directly or indirectly) or to the plant via the same composition (that is, they are formulated together). In one aspect, at least two different compositions can be used. In an aspect, two different compositions contain at least two different LCOs. In at least one aspect, different compositions can be formulated separately, and both compositions are applied to a seed or plant. In another aspect, a different composition is applied to seeds than is applied to different parts of the plants, for example, without limitation, green tissue.

In one aspect, seeds can be treated with any composition and in a particular aspect a LCO in multiple ways including, without limitation, via spraying or dripping. Spray and drip treatment can be conducted, for example, by formulating an effective amount of any composition including, without limitation, an LCO in an agronomically acceptable carrier, typically aqueous in nature, and spraying or dripping the composition onto seed via a continuous treating system (which is calibrated to apply treatment at a predefined rate in proportion to the continuous flow of seed), such as a drum-type of treater. Such methods include those that can advantageously employ relatively small volumes of carrier so as to allow for relatively fast drying of the treated seed. Large volumes of seeds can be efficiently treated. Batch systems, in which a predetermined batch size of seed and signal molecule compositions are delivered into a mixer, can also be employed. Systems and apparatuses for performing these processes are commercially available from numerous suppliers, e.g., Bayer CropScience (Gustafson).

A composition can, in one aspect, comprise at least two, three, four, five, or more LCOs, which can be applied just prior to, at the time of planting, or after planting. Treatment at the time of planting includes, without limitation, direct application to the seed and introducing the LCOs into the soil. Such treatments include, without limitation, furrow treatment. In an aspect, seeds can be then packaged, e.g., in 50-lb or 100-lb bags, or bulk bags or containers, in accordance with standard techniques. In an aspect, treated seeds can be stored for at least 1, 2, 3, 4, 5, 6, 7, 8, 9, 10, 11, or 12 months, and even longer, e.g., 13, 14, 15, 16, 17, 18, 19, 20, 21, 22, 23, 24, 25, 26, 27, 28, 29, 30, 31, 32, 33, 34, 35, 36 months, or even longer, under appropriate storage conditions which are known in the art.

In one aspect, a composition contains an effective amount of an ingredient. In one aspects an effective amount of composition used to treat the seed, expressed in units of concentration, can be any effective concentration but in certain aspects ranges from about 10⁻⁵ to about 10⁻¹⁴ M (molar concentration), and in another aspect, from about 10⁻⁵ to about 10⁻¹¹ M, and in a further aspect from about 10⁻⁷ to about 10⁻⁸ M. Expressed in units of weight, the effective amount can be any amount but in one aspect ranges from about 1 to about 400 g/hundred weight (cwt) seed, and in another aspect from about 2 to about 70 g/cwt and in a further aspect, from about 2.5 to about 3.0 g/cwt seed.

In one aspect, a seed treatment can be direct or indirect. For purposes of indirect treatment of seed, it can include, without limitation, an in-furrow treatment, an effective amount of which can be any effective amount of the active ingredient and, in one aspect, and for the LCO can range from 1 g/acre to about 70 g/acre, and in another aspect, from about 50 g/acre to about 60 g/acre. For purposes of direct application to the plants, an effective amount can be any effective amount, and in one aspect and for the LCO composition can range from 1 g/acre to about 30 g/acre, and in a further aspect, from about 11 g/acre to about 20 g/acre.

In one aspect, an effective amount of LCO composition can be applied as a foliar application to a plant in a range from about 10⁻⁵ to about 10⁻¹¹ M, and in a further aspect from about 10⁻⁷ to about 10⁻⁹ M, and in a further aspect from about 10⁻⁸.

In an aspect, the composition is coated on the seed, where the composition is coated at a rate in a range of about 0.25 to 1 and in another embodiment at a rate of about 0.5 fl ounces/cwt (0.9 mg/seed) of LCO.

In an aspect, the composition is applied in-furrow or to the soil of the field prior to planting at a rate in a range of about 8 to 16 ounces per acre.

In an aspect, the composition is applied to the foliage of a corn plant growing in the field at a rate of about 1, 2, 3, 4, 5, 6, 7, 8, 9, 10, 11, 12, 13, 14, 15, 16, 17, 18, 19, 20 or more ounces per acre.

In another embodiment, the compositions and methods described herein include a microorganism and/or pesticide. The pesticide may be, for example, an insecticide, a fungicide, an herbicide, or a nematicide.

### Microorganisms

In another aspect, microorganisms can be included in the compositions and methods disclosed herein. Examples of microbes include bacteria from the genera Rhizobium spp. (e.g., R. cellulosilyticum, R. daejeonense, R. etli, R. galegae, R. gallicum, R. giardinii, R. hainanense, R. huautlense, R. indigoferae, R. legurninosarm, R. loessense, R. lupini, R. lusitanum, R. meliloti, R. mongolense, R. miluonense, R. sullae, R. tropici, R. undicola, and/or R. yanglingense), Bradyrhizobium spp. (e.g., B. bete, B. canariense, B. elkanii, B. iriomotense, B. japonicum, B. jicamae, B. liaoningense, B. pachyrhizi, and/or B. yuanmingense), Azorhizobium spp. (e.g., A. caulinodans and/or A. doebereinerae). Sinorhizobium spp. (e.g., S. abri, S. adhaerens, S. americanum, S. aboris, S. fredii, S. indiaense, S. kostiense, S. kummerowiae, S. medicae, S. meliloti, S. mexicanus, S. morelense, S. saheli, S. terangae, and/or S. xinjiangense), Mesorhizobium spp., (M. albiziae, M. amorphae, M. chacoense, M. ciceri, M. huakuii, M. loti, M. mediterraneum, M. pluifarium, M. septentrionale, M. temperatum, and/or M. tianshanense), and combinations thereof. In further aspect, the microorganism is applied at a rate of about 1×10², 5×10², 1×10³, 5×10³, 1×10⁴, 5×10⁴, 1×10⁴, 5×10⁵, 1×10⁶, 5×10⁶, 1×10⁷, 5×10⁷, or 1×10⁸ colony forming units per seed.

The composition can include a microorganism that improves organic P mobilization (phytase), nitrogen use efficiency, micronutrient availability, or is a phosphate solubilizing microorganism. In one aspect, the phosphate solubilizing microorganism includes, but is not limited to, the Penicillium genus. In one aspect, the composition does not include a phosphate solubilizing microorganism.

As used herein, the term of “phosphate solubilizing” is intended to mean the conversion of insoluble phosphate (e.g., rock phosphate, etc.) into a soluble phosphate form.

As used herein, “phosphate solubilizing microorganism” is a microorganism that is able to increase the amount of phosphorous available for a plant, including but not limited to, increasing phosphorous in the soil. Phosphate solubilizing microorganisms include fungal and bacterial microbial species. Non-limiting examples of phosphate solubilizing microorganisms include, without limitation, species from a genus selected from the group consisting of Acinetobacter, Arthrobacter, Arthrobotrys, Aspergillus, Azospirillum, Bacillus, Burkholderia, chryseomonas, Enterobacter, Eupenicillium, Exiguobacterium, Klebsiella, Kluyvera, Microbacterium, Mucor, Paecilomyces, Paenibacillus, Penicillium, Pseudomonas, Serratia, Stenotrophomonas, Streptomyces, Streptosporangium, Swaminathania, Thiobacillus, Torulospora, Vibrio, Xanthobacter, and Xanthomonas.

Non-limiting examples of phosphate solubilizing microorganisms can be also selected from the group consisting of Acinetobacter calcoaceticus, Acinetobacter sp, Arthrobacter sp., Arthrobors oligospora, Aspergllus niger, Aspergtllus sp., Azospirillum halopraeferans, Bacillus subtilis, Burkholderia cepacia, Burkholderia vienamiensis, Candida krissii, Chryseomonas luieola, Enterobacter aerogenes, Enterobacter asburiae, Enterobacter sp., Enterobacter taylorae, Eupenicillium parvum, Exiguohacterium sp., Klebsiella sp., Kluyvera cryocrescens, Microbacterium sp., Mucor ramosissimus, Paecilomyces hepialid, aglomerans, Penicillium expansum, Pseudomonas corrugate, Pseudomonas fluorescens, Pseudomonas lutea, Pseudomonas poae, Pseudomonas putida, Pseudomonas stuizeri, Pseudomonas trivialis, Serratia marcescens, Stenotrophomonas maliophilia, Streptomyces sp., Streptosporangium sp., Swaminathania salitolerans, Thiobacillus ferrooxidans, Torulospora globosa, Vibrio proteolyticus, Xanthobacter agilis, and Xanthomonas campestris.

### Herbicides

As used herein, the term “herbicide(s)” means any agent or combination of agents capable of killing weeds and/or inhibiting the growth of weeds (the inhibition being reversible under certain conditions). Herbicides can be utilized in an aspect of the present disclosure. In one aspect, a herbicide can be used in combination with either a composition of the present disclosure or a part of a method of the present disclosure.

Suitable herbicides used in the compositions and methods disclosed herein include acetochlor, clethodim, dicamba, flumioxazin, fomesafen, mesotrione, quizalofop, saflufenacil, sulcotrione, S-3100 and 2,4-D, bentazon, acifluorfen, chlorimuron, lactofen, clomazone, fluazifop, glufosinate, glyphosate, sethoxydim, imazethapyr, imazamox, fomesafe, flumiclorac, imazaquin, and clethodim. Commercial products containing each of these compounds are readily available. Herbicide concentration in the composition will generally correspond to the labeled use rate for a particular herbicide.

In one aspect, the compositions described herein can further comprise one or more herbicides. Suitable herbicides include, without limitation, chemical herbicides, natural herbicides (e.g., bioherbicides, organic herbicides, etc.), or combinations thereof. Non-limiting examples of suitable herbicides include, without limitation, bentazon, acifluorfen, chlorimuron, lactofen, clomazone, fluazifop, glufosinate, glyphosate, sethoxydim, imazethapyr, imazamox, fomesafe, flumiclorac, imazaquin, clethodim, pendimethalin; 3,4-Dimethyl-2,6-dinitro-N-pentan-3-yl-aniline; N-(1-ethylpropyl)-2,6-dinitro-3,4-xylidine; pronamide; propyzamide; 3,5-Dichloro-N-(1,1-dimethylpropynyl)benzamide; 3,5-Dichloro-N-(1,1-dimethyl-2-propynyl)benzamide; N-(1,1-Dimethylpropynyl)-3,5-dichlorobenzamide; S-ethyl N-ethylthiocyclohexanecarbamate; trifluralin; 2,6-Dinitro-N,N-dipropyl-4-(trifluoromethyl)aniline; glyphosate; N-(phosphonomethyl)glycine; and derivatives thereof. In one aspect, the one or more herbicides for use in accordance with this disclosure include, without limitation, pronamide (commercially referred to as Kerb®); propyzamide; 3,5-Dichloro-N-(1,1-dimethylpropynyl)benzamide; 3,5-Dichloro-N-(1,1-dimethyl-2-propynyl)benzamide; N-(1,1-Dimethylpropynyl)-3,5-dichlorobenzamide; cycloate, S-ethyl N-ethylthiocyclohexanecarbamate (commercially referred to as Ro-Neet®); trifluralin; 2,6-Dinitro-N,N-dipropyl-4-(trifluoromethyl)aniline; glyphosate; N-(phosphonomethyl)glycine; and derivatives thereof. Commercial products containing each of these compounds are readily available. Herbicide concentration in the composition will generally correspond to the labeled use rate for a particular herbicide.

### Fungicide(s)

As used herein, the term “fungicide(s)” means any agent or combination of agents capable of killing fungi and/or inhibiting fungal growth. Fungicides can be utilized in an aspect of the present disclosure. In one aspect, fungicide can be used in combination with either a composition of the present disclosure or a part of a method of the present disclosure.

In one aspect, the compositions described herein can further comprise one or more fungicides. Fungicides useful to the compositions described herein will suitably exhibit activity against a broad range of pathogens, including but not limited to Phytophthora, Rhizoctonia, Fusarium, Pythium, Phomopsis, or Selerotinia and Phakopsora, and combinations thereof.

Non-limiting examples of useful fungicides include aromatic hydrocarbons, benimidazoles, benzthiadiazole, carboxamides, carboxylic acid amides, morpholines, phenylamides, phosphonates, quinone outside inhibitors (e.g. strobilurins), thiazolidines, thiophanates, thiophene carboxamides, and triazoles. Particular examples of fungicides include acibenzolar-S-methyl, azoxystrobin, benalaxyl, bixafen, boscalid, carbendazim, cyproconazole, dimethomorph, epoxiconazole, fludioxonil, fluopyram, fluoxastrobin, flutianil, flutolanil, fluxapyroxad, fosetyl-Al, ipconazole, isopyrazam, kresoxim-methyl, mefenoxam, metalaxyl, metconazole, myclobutanil, orysastrobin, penflufen, penthiopyrad, picoxystrobin, propiconazole, prothioconazole, pyraclostrobin, sedaxane, silthiofam, tebuconazole, thiabendazole, thifluzamide, thiophanate, tolclofos-methyl, trifloxystrobin, and triticonazole. In one aspect, the fungicide include pyraclostrobin, propiconazole, trifloxystrobin, azoxystrobin, fluxapyroxad, and combinations thereof.

Non-limiting examples of commercial fungicides which can be suitable for the compositions disclosed herein include, without limitation, PROTÉGÉ, RIVAL or ALLEGIANCE FL or LS (Gustafson, Plano, Tex.), WARDEN RTA (Agrilance, St. Paul, Minn.), APRON XL, APRON MAXX RTA or RFC, MAXIM 4FS or XL (Syngenta, Wilmington, Del.), CAPTAN (Arvesta, Guelph, Ontario) and PROTREAT (Nitragin Argentina, Buenos Ares, Argentina). Active ingredients in these and other commercial fungicides include, but are not limited to, fludioxonil, mefenoxam, azoxystrobin and metalaxyl. Commercial fungicides are most suitably used in accordance with the manufacturer's instructions at the recommended concentrations.

### Insecticide(s)/Nematicide(s)/Acaricide(s)

As used herein, the term “insecticide(s)” means any agent or combination of agents capable of killing one or more insects and/or inhibiting the growth of one or more insects. Insecticides can be utilized in an aspect of the present disclosure. In one aspect, an insecticide, nematicide, or acaricide can be used in combination with either a composition of the present disclosure or a part of a method of the present disclosure.

As used herein, the term “nematicide(s)” means any agent or combination of agents capable of killing one or more nematodes and/or inhibiting the growth of one or more nematodes. Nematicides can be utilized in an aspect of the present disclosure.

As used herein, the term “acaricide(s)” means any agent or combination of agents capable of killing one or more acarids and/or inhibiting the growth of one or more acarids. Acaricides can be utilized in an aspect of the present disclosure.

In one aspect, the compositions described herein can further comprise one or more insecticides, acaricides, nematicides, or combinations thereof. Insecticides useful to the compositions described herein will suitably exhibit activity against a broad range of insects including, but not limited to, wireworms, cutworms, grubs, corn rootworm, seed corn maggots, flea beetles, chinch bugs, aphids, leaf beetles, stink bugs, and combinations thereof. The insecticides, acaricides, and nematicides described herein can be chemical or natural (e.g., biological solutions, such as fungal pesticides, etc.).

Non-limiting examples of insecticides and nematicides include carbamates, diamides, macrocyclic lactones, neonicotinoids, organophosphates, phenylpyrazoles, pyrethrins, spinosyns, synthetic pyrethroids, tetronic and tetramic acids. In particular embodiments insecticides and nematicides include abamectin, aldicarb, aldoxycarb, bifenthrin, carbofuran, chlorantraniliporle, chlothianidin, cyfluthrin, cyhalothrin, cypermethrin, cyantraniliprole, deltamethrin, dinotefuran, emamectin, ethiprole, fenamiphos, fipronil, flubendiamide, fosthiazate, imidacloprid, ivermectin, lambda-cyhalothrin, milbemectin, nitenpyram, oxamyl, permethrin, spinetoram, spinosad, spirodichlofen, spirotetramat, tefluthrin, thiacloprid, thiamethoxam, and thiodicarb. Suitable amounts or insecticides and nematicides for use according to the present disclosure are known in the art.

Non-limiting examples of commercial insecticides which can be suitable for the compositions disclosed herein include, without limitation, CRUISER (Syngenta, Wilmington, Del.), GAUCHO and PONCHO (Gustafson, Plano, Tex.). Active ingredients in these and other commercial insecticides include, without limitation, thiamethoxam, clothianidin, and imidacloprid. Commercial insecticides are most suitably used in accordance with the manufacturer's instructions at the recommended concentrations.

Non-limiting examples of insecticides, acaricides, and nematicides that can be useful to the compositions disclosed herein include, without limitation, carbamates, diamides, macrocyclic lactones, neonicotinoids, organophosphates, phenylpyrazoles, pyrethrins, spinosyns, synthetic pyrethroids, tetronic and tetramic acids.

In an aspect, insecticides, acaricides, and nematicides include, without limitation, acrinathrin, alpha-cypermethrin, betacyfluhrin, cyhalothrin, cypermethrin, deltamethrin csfenvalcrate, etofenprox, fenpropathrin, fenvalerate, flucythrinat, fosthiazate, lambda-cyhalothrin, gamma-cyhalothrin, permethrin, tau-fluvalinate, transfluthrin, zeta-cypermethrin, cyfluthrin, bifenthrin, tefluthrin, eflusilanat, fubfenprox, pyrethrin, resmethrin, imidacloprid, acetamiprid, thiamethoxam, nitenpyram, thiacloprid, dinotefuran, clothianidin, imidaclothiz, chlorfluazuron, diflubenzuron, lufenuron, teflubenzuron, triflumuron, novaluron, flufenoxuron, hexaflumuron, bistrifluoron, noviflumuron, buprofezin cyromazine, methoxyfenozide, tebufenozide, halofenozide, chromafenozide, endosulfan, fipronil, ethiprole, pyrafluprole, pyriprole, flubendiamide, chlorantraniliprole (Rynaxypyr), chlothianidin, cyazypyr, emamectin, emamectin benzoate, abamectin, ivermectin, milbemectin, lepimectin, tebufenpyrad, fen pyroxi mate, pyridaben, fenazaquin, pyrimidifen, tolfenpyrad, dicofol, cyenopyrafen, cyflumetofen, acequinocyl, fluacrypyrin, bifenazate, diafenthiuron, etoxazole, clofentezine, spinosad, triarathen, tetradifon, propargite, hexythiazox, bromopropylate, chinomethionat, amitraz, pyrifluquinazon, pymetrozine, flonicamid, pyriproxyfen, diofenolan, chlorfenapyr, metaflumizone, indoxacarb, chlorpyrifos, spirodiclofen, spiromesifen, spirotetramat, pyridalyl, spinctoram, acephate, triazophos, profenofos, oxamyl, spinetoram, fenamiphos, fenamipclothiahos, 4-{[(6-chloropyrid-3-yl)methyl](2,2-difluoroethyl)amino}furan-2(5H)-one, cadusaphos, carbaryl, carbofuran, ethoprophos, thiodicarb, aldicarb, aldoxycarb, metamidophos, methiocarb, sulfoxaflor, cyantniliprole, and also products based on Bacillus firmus (1-1582, BioNeem, Votivo), and combinations thereof.

In another aspect, corn seeds are treated with a composition selected from the group consisting of cantraniliprole, thiamethoxam, clothianidin, imidacloprid, sedaxane, azoxystrobin, fludioxonil, metalaxyl, mefenoxam, thiabenzole, prothioconazole, fluoxastrobin, fluxapyroxad, fluopyram, pyraclostrobin, Votivo, a second LCO, Penicillium bilaii, Bradyrhizobium japonicum, and combinations thereof.

Additional active components may also comprise substances such as biological control agents, microbial extracts, natural products, plant growth activators or plant defense agents. Non-limiting examples of biological control agents include bacteria, fungi, beneficial nematodes, and viruses.

In certain embodiments, the biological control agent can be a bacterium of the genus Actinomycetes, Agrobacterium, Arthrobacter, Alcaligenes, Aureobacterium, Azobacter, Beijerinckia, Brevibacillus, Burkholderia, Chromobacterium, Clostridium, Clavibacter, Comomonas, Corynebacterium, Curtobacterium, Enterobacter, Flavobacterium, Gluconabacter, Hydrogenophage, Klebsiella, Methylobacterium, Paenibacillus, Pasteuria, Phingobacterium, Photorhabdus, Phyllobacterium, Pseudomonas, Rhizobium, Serratia, Stenotrophomonas, Streptomyces, Variovorax, and Xenorhadbus. In particular embodiments the bacteria is selected from the group consisting of Bacillus amyloliquefaciens, Bacillus cereus, Bacillus firmus, Bacillus lichenformis, Bacillus pumilus, Bacillus sphaericus, Bacillus subtilis, Bacillus thuringiensis, Bradyrhizobium japonicum, Chromobacterium suttsuga, Pasteuria nishizawae, Pasteuria penetrans, Pasteuria usage, Pseudomona fluorescens, and Streptomyces lydicus.

In certain embodiments the biological control agent can be a fungus of the genus Alternaria, Ampelomyces, Aspergillus, Aureobasidium, Beauveria, Colletotrichurn, Coniothyrium, Gliocladium, Metarhisium, Muscodor, Paecilonyces, Penicillium, Trichoderma, Typhula, Ulocladium, and Verticilium. In particular embodiments the fungus is Beauveria bassiana, Coniothyrium minttans, Gliocladium virens, Metarhizium anisopliae, Muscodor albus, Paecilomyces lilacinus, Penicllium bilati, Trichoderma polysporum, and Trichoderma virens.

In further embodiments the biological control agents can be plant growth activators or plant defense agents including, but not limited to harpin, Reynoutria sachalinensis, jasmonate, lipochitooligosaccharides, and isoflavones.

In an aspect, the insecticide is a microbial insecticide. In a more particular aspect, the microbial insecticide is a fungal insecticide. Non-limiting examples of fungal insecticides that can be used in the compositions disclosed herein are described in McCoy, C. W., Samson, R. A., and Coucias, D. G. “Entomogenous fungi.” In “CRC Handbook of Natural Pesticides. Microbial Pesticides, Part A. Entomogenous Protozoa and Fungi.” (C. M. Inoffo, ed.), (1988): Vol. 5, 151-236; Samson, R. A., Evans, H. C., and Latge. J. P. “Atlas of Entomopathogenic Fungi.” (Springer-Verlag, Berlin) (1988); and deFaria, M. R, and Wraight, S. P. “Mycoinsecticides and Mycoacaricides: A comprehensive list with worldwide coverage and international classification of formulation types.” Biol. Control (2007), doi: 10.1016/j.biocontrol.2007.08.001.

In an aspect, non-limiting examples fungal insecticides that can be used in the compositions disclosed herein include, without limitation, species of Coelomyecidium, Myiophagus, Coelemomyces, Lagenidium, Leptolegnia, Couchia, Sporodiniella, Conidiobolus, Entomophaga, Entomophthora, Erynia, Massospora, Meristacrum, Neozygites, Pandora, Zoophihora, Blastodendrion, Metschnikowia, Mycoderma, Ascophaera, Cordyceps, Torrubiella, Nectria, Hypocrella, Calonectria, Filariomyces, Hesperomyces, Trenomyces, Myriangiun, Podonectria, Akanthomyces, Aschersonia, Aspergillus, Beauveria. Culicinomyces, Engyodontium, Fusarium, Gibellula, Hirsutella, Hymenostilbe, Isaria, Metarhizium, Nomurarea, Paecilomymes, Paraisaria, Pleurodesmospora, Polycephalomyces, Peuogibellula, Sorosporella, Stillbella, Tetranacrium, Tilachlidium, Tolypocladium, Verticillium, Aegerita, Filobasidiella, Septobasidium, Uredinella, and combinations thereof.

Non-limiting examples of particular species that can be useful as a fungal insecticide in the compositions described herein include, without limitation. Trichoderma hamarum, Trichoderma hazarium, Alternaria cassiae, Fusarium lateritum, Fusarium solani, Lecanicillium lecanii, Aspergillus parasiticus, Verticillium lecanii, Metarhizium anisopliae, and Beauveria bassiana. In an aspect, the compositions disclosed herein can include any of the fungal insecticides provided above, including any combination thereof.

### Fertilizer(s)

As used herein. “fertilizer(s)” is intended to mean any material of natural or synthetic origin that is applied to soils or to plant tissues to supply one or more plant nutrients essential to the growth of plants. Fertilizers can be utilized in an aspect of the present disclosure. In one aspect, a fertilizer can be used in combination with either a composition of the present disclosure or a part of a method of the present disclosure.

Commercially available manufactured phosphate fertilizers are of many types. Some common ones are those containing rock phosphate, monoammonium phosphate, diammonium phosphate, monocalcium phosphate, super phosphate, triple super phosphate, and/or ammonium polyphosphate. By means of the present disclosure it may be possible to reduce the amount of these fertilizers applied to the soil while still maintaining the same amount of phosphorus uptake from the soil.

An organic fertilizer refers to a soil amendment derived from natural sources that guarantees, at least, the minimum percentages of nitrogen, phosphate, and potash. Non-limiting examples of organic fertilizers include, without limitation, plant and animal by-products, rock powders, seaweed, compositions, and conditioners. These are often available at garden centers and through horticultural supply companies. In particular, the organic source of phosphorus is from bone meal, meat meal, animal manure, compost, sewage sludge, or guano, or combinations thereof.

### Chitinous Compounds

As used herein, “chitinous compounds” are intended to mean chitins and chitosans, which are major components of the cell walls of fungi and the exoskeletons of insects and crustaceans, and are also composed of GlcNAc residues. In one aspect, a chitinous compound can be used in combination with, or be part of, either a composition of the present disclosure or a part of a method of the present disclosure.

Chitinous compounds include, without limitation, chitin, (IUPAC: N-[5-[[3-acetylamino-4,5-dihydroxy-6-(hydroxymethyl)oxan-2yl]methoxymethyl]-2-[[5-acetylamino-4,6-dihydroxy-2-(hydroxy methyl)oxan-3-yl]methoxymethyl]-4-hydroxy-6-(hydroxymethyl)oxan-3-ys]ethanamide), and chitosan, (IUPAC: 5-amino-6-[5-amino-6-[5-amino-4,6-dihydroxy-2(hydroxymethyl)oxan-3-yl]oxy-4-hydroxy-2-(hydroxymethyl)oxan-3-yl]oxy-2(hydroxymethyl)oxane-3,4-diol). These compounds can be obtained commercially, e.g., from Sigma-Aldrich, or prepared from insects, crustacean shells, or fungal cell walls. Methods for the preparation of chitin and chitosan are known in the art, and have been described, for example, in U.S. Pat. No. 4,536,207 (preparation from crustacean shells), Pochanavanich, et al., Lett. Appl. Microbiol. 35:17-21 (2002) (preparation from fungal cell walls), and U.S. Pat. No. 5,965,545 (preparation from crab shells and hydrolysis of commercial chitosan). Deacetylated chitins and chitosans can be obtained that range from less than 35% to greater than 90% deacetylation, and cover a broad spectrum of molecular weights, e.g., low molecular weight chitosan oligomers of less than 15 kD and chitin oligomers of 0.5 to 2 kD: “practical grade” chitosan with a molecular weight of about 15 kD; and high molecular weight chitosan of up to 70 kD. Chitin and chitosan compositions formulated for seed treatment are also commercially available. Commercial products include, without limitation, for example, ELEXA® (Plant Defense Boosters, Inc.) and BEYOND™ (Agrihouse, Inc.). Chitinous compounds can be utilized in an aspect of the present disclosure.

### Flavonoids/Jasmonic Acid/Linolenic Acid

In one aspect, a flavonoid, jasmonic acid or linolenic acid can be used in combination with, or be part of, either a composition of the present disclosure or part of a method of the present disclosure. Flavonoids are phenolic compounds having the general structure of two aromatic rings connected by a three-carbon bridge.

Classes of flavonoids include, without limitation, chalcones, anthocyanidins, coumarins, flavones, flavanols, flavonols, flavanones, and isoflavones. See, Jain, et al., J. Plant Blochem. & Biotechnol. 77:1-10 (2002); Shaw, et al., Environmental Microbiol. 77:1867-80 (2006).

As used herein, the term “isoflavonoids” means phytoestrogens, isoflavones (e.g., genistein, daidrzein, glycitein, etc.), and isoflavanes (e.g., equol, lonchocarpane, laxiflorane, etc.). Isoflavonoids can be utilized in an aspect of the present disclosure. In one aspect, isoflavonoids can be used in combination with, or be part of, either a composition of the present disclosure or a part of a method of the present disclosure.

Representative flavonoids that can be useful in the practice of the present disclosure include, without limitation, genistein, daidzein, formononetin, naringenin, hesperetin, luteolin, and apigenin. Jasmonic acid (JA, [1 R-[1 a,2 (Z)]]-3-oxo-2-(pentenyl)cyclopentaneacetic acid) and its derivatives, linoleic acid ((Z,Z)-9,12-Octadecadienoic acid) and its derivatives, and linolenic acid ((Z,Z,Z)-9,12,15-octadecatrienoic acid) and its derivatives, can be used in the practice of the present disclosure. Jasmonic acid and its methyl ester, methyl jasmonate (MeJA), collectively known as jasmonates, are octadecanoid-based compounds that occur naturally in plants. Jasmonic acid may be produced by the roots of wheat seedlings, and by fungal microorganisms such as Botryodiplodia theobromae and Gibberella fujikuroi, yeast (Sacchromyces cerevisiae), and pathogenic and non-pathogenic strains of Escherichia coli. Jasmonates, linoleic acid and linoleic acid (and their derivatives) are reported to be inducers of nod gene expression or LCO production by rhizobacteria. See, e.g., Mabood, Fazli, “Jasmonates induce the expression of nod genes in Bradyrhizobium japonicum,” May 17, 2001; and Mabood, Fazli, “Linoleic and linolenic acid induce the expression of nod genes in Bradyrhizobium japonicum,” USDA 3, May 17, 2001.

Useful derivatives of linoleic acid, linolenic acid, and jasmonic acid that can be useful in the practice of the methods herein include, without limitation, esters, amides, glycosides and salts. Representative esters are compounds in which the carboxyl group of linoleic acid, linolenic acid, or jasmonic acid has been replaced with a —COR group, where R is an —OR¹ group, in which R¹ is: an alkyl group, such as a C₁-C₈ unbranched or branched alkyl group, e.g., a methyl, ethyl or propyl group: an alkenyl group, such as a C₂-C₈ unbranched or branched alkenyl group; an alkynyl group, such as a C₂-C₈ unbranched or branched alkynyl group; an aryl group having, for example, 6 to 10 carbon atoms; or a heteroaryl group having, for example, 4 to 9 carbon atoms, wherein the heteroatoms in the heteroaryl group can be, for example, N, O, P, or S. Representative amides are compounds in which the carboxyl group of linoleic acid, linolenic acid, or jasmonic acid has been replaced with a —COR group, where R is an NR²R³ group, in which R² and R³ are independently hydrogen; an alkyl group, such as a C₁-C₈ unbranched or branched alkyl group, e.g., a methyl, ethyl or propyl group; an alkenyl group, such as a C₂-C₈ unbranched or branched alkenyl group; an alkynyl group, such as a C₂-C₈ unbranched or branched alkynyl group; an aryl group having, for example, 6 to 10 carbon atoms: or a heteroaryl group having, for example, 4 to 9 carbon atoms, wherein the heteroatoms in the heteroaryl group can be, for example, N, O, P, or S. Esters can be prepared by known methods, such as acid-catalyzed nucleophilic addition, wherein the carboxylic acid is reacted with an alcohol in the presence of a catalytic amount of a mineral acid. Amides can also be prepared by known methods, such as by reacting the carboxylic acid with the appropriate amine in the presence of a coupling agent such as dicyclohexyl carbodiimide (DCC), under neutral conditions. Suitable salts of linoleic acid, linolenic acid, and jasmonic acid include, without limitation, e.g., base addition salts. The bases that can be used as reagents to prepare metabolically acceptable base salts of these compounds include those derived from cations such as alkali metal cations (e.g., potassium and sodium) and alkaline earth metal cations (e.g., calcium and magnesium). These salts can be readily prepared by mixing together a solution of linoleic acid, linolenic acid, or jasmonic acid with a solution of the base. The salt can be precipitated from solution and be collected by filtration or can be recovered by other means such as by evaporation of the solvent.

### Karrikins

Karrikins are vinylogous 4H-pyrones e.g., 2H-furo[2,3-c]pyran-2-ones. In one aspect, an Karrikins can be used in combination with, or be part of, either a composition of the present disclosure or a part of a method of the present disclosure. In one aspect, Karrikins include, without limitation, derivatives and analogues thereof. Examples of these compounds are represented by the following structure:

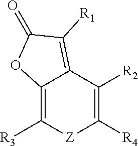

wherein; Z is O, S or NR₅; R₁, R₂, R₃, and R₄ are each independently H, alkyl, alkenyl, alkynyl, phenyl, benzyl, hydroxy, hydroxyalkyl, alkoxy, phenyloxy, benzyloxy, CN, COR₆, COOR═, halogen, NR₆R₇, or NO₂; and R₅, R₆, and R₇, are each independently H, alkyl or alkenyl, or a biologically acceptable salt thereof. Examples of biologically acceptable salts of these compounds can include, without limitation, acid addition salts formed with biologically acceptable acids, examples of which include, without limitation, hydrochloride, hydrobromide, sulphate or bisulphate, phosphate or hydrogen phosphate, acetate, benzoate, succinate, fumarate, maleate, lactate, citrate, tartrate, gluconate; methanesulphonate, benzenesulphonate and p-toluenesulphonic acid. Additional biologically acceptable metal salts can include, without limitation, alkali metal salts, with bases, examples of which include the sodium and potassium salts. Examples of compounds embraced by the structure and which can be suitable for use in the present disclosure include, without limitation, the following: 3-methyl-2H-furo[2,3-c]pyran-2-one (where R₁═CH₃, R₂, R₃, R₄═H), 2H-furo[2,3-c]pyran-2-one (where R₁, R₂, R₃, R₄ ═H), 7-methyl-2H-furo[2,3-c]pyran-2-one (where R₁, R₂, R₄═H, R₃═CH), 5-methyl-2H-furo[2,3-c]pyran-2-one (where R₁, R₂, R₃═H, R₄═CH₃), 3,7-dimethyl-2H-furo[2,3-c]pyran-2-one (where R₁, R₃ ═CH₃, R₂, R₄═H), 3,5-dimethyl-2H-furo[2,3-c]pyran-2-one (where R₁, R₄═CH₃, R₂, R₃═H), 3,5,7-trinnethyl-2H-furo[2,3-c]pyran-2-one (where R₁, R₃, R₄═CH₃, R₂═H), 5-methoxymethyl-3-nnethyl-2H-furo[2,3-c]pyran-2-one (where R₁ ═CH3, R₂, R₃═H, R₄ ═CH₂OCH₃), 4-bromo-3,7-dimethyl-2H-furo[2,3-c]pyran-2-one (where R₁, R₃ ═CH₃, R₂═Br, R₄═H), 3-methylfuro[2,3-c]pyridin-2(3H)-one (where Z═NH, R₁ ═CH₃, R₂, R₃, R₄═H), 3,6-dimethylfuro[2,3-c]pyridin-2(6H)-one (where Z═N—CH₃, R₁ ═CH₃, R₂, R₃, R₄═H). See, U.S. Pat. No. 7,576,213. These molecules are also known as Karrikins. See, Halford, supra. Karrikins can be utilized in an aspect of the present disclosure.

### Methods

In one aspect, the present disclosure provides growing a corn plant or corn seed in soil applied with a composition comprising a lipo-chitooligosaccharide (LCO) after one or more consecutive corn plantings in the soil where the composition is capable of reducing a corn-on-corn yield penalty.

In one aspect the soil is present in a field. A field can be any field. In one aspect, an area of land, enclosed or otherwise, is used for agricultural purposes such as cultivating crops. In one aspect, a field or area of land/soil for growing corn is greater than 100 square meters, 500 square meters, 1 acre, 5 acres, 10 acres, 20 acres, or 50 acres.

In one aspect, a consecutive corn planting is any continuous corn planting in which a first corn planting in an earlier growing season is followed by a second corn planting in a later growing season and not interrupted by a non-corn planting. In one aspect, a non-corn can be a nitrogen-fixing plant, the nitrogen-fixing plant may or may not be a leguminous plant, and the leguminous plant may or may not be a soybean plant. In addition, the non-corn may be a non-nitrogen fixing plant including but not limited to, wheat and cotton.

In one aspect, consecutive corn planting(s) may be 2, 3, 4, 5 or 6 or more consecutive corn plantings without an intervening non-corn rotation.

In one aspect, a planting can be a consecutive non-nitrogen fixing planting.

In one aspect, consecutive non-nitrogen fixing plant planting is any continuous non-nitrogen fixing plant planting in which first non-nitrogen fixing plant planting in an earlier growing season is followed by a second non-nitrogen fixing plant planting in a later growing season and not interrupted by a nitrogen fixing plant planting.

As used herein, the term “corn-on-corn” is intended to mean corn plantings in two or more consecutive growing seasons in the same fields and not rotated with a non-corn crop.

In one aspect, a method or composition results in the reduction of a corn-on-corn yield penalty. As used herein, the term “corn-on-corn yield penalty” (CCYP) is defined as follows:

CCYP=Y_{NC}−Y_{CC}

in which, Y_{NC} is the yield of corn in a later growing season following an immediate prior planting of a non-corn (NC) plant in an earlier growing season, where the non-corn may be a nitrogen-fixing plant, the nitrogen-fixing plant may or may not be a leguminous plant, and the leguminous plant may or may not be a soybean plant. In addition, the non-corn may be a non-nitrogen fixing plant, including but not limited to, wheat and cotton: and Y_{CC} is the yield of corn in a later growing season following an immediate prior planting of corn in an earlier growing season. In one aspect, CCYP is measured as set forth in Example 2.

In one aspect the reduction of a corn-on-corn yield penalty is more than 3%, 5%, 10%, 15% or 20% of an untreated corn seed or plant. In one aspect, corn-on-corn yield penalty is measured on a single plant. In other aspects, a corn-on-corn yield penalty is measured on a group of plants where the group of plants is greater than 100, 200, 500, or 1000 corn plants. In one aspect, CCYP reduction is a capability of a provided composition or method.

In an aspect, the composition is applied to the corn seeds prior to planting. In an aspect, the applying is at least 0.25, 0.5, 0.75, 1, 2, 3, 4, 5, 6, 7, 8, 9, 10, 11, 12, 15, 18, 21, 24, 27, 30, 33, 36 months or more prior to planting, in an aspect, corn was sown in the soil for at least the previous two or more consecutive growing seasons. In an aspect, the at least previous two or more growing seasons is the previous three, four, five, six, seven, eight, nine, ten or more growing seasons. In an aspect, the method is capable of reducing the corn-on-corn yield penalty from consecutive corn planting by at least about 5, 10, 15, 20, 25, 30, 35, 40, 45, 50, 55, 60, 65, 70, 75, 80, 85, 90, 95% or more. In an aspect, the corn-on-corn yield penalty is less than 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or 50 bushels/acre.

In one aspect. “applying” or “applied” can be performed by any person but, without limitation, can be performed in its entirety by a farmer, a farm worker, a laborer, a seed distributor, an agrochemical company, an agricultural technology company, or any other parties similarly situated.

In one aspect the present disclosure includes a method of crop rotation management that provides for two consecutive corn plantings in a field where the later planting provides a yield that is at least 80%, 82%, 84%, 86%, 88%, 90%, 92%, 94%, 96%, 98%, 100%, 102%, 104%, 106%, 108%, 110%, 115%, 120%, or 125% of the yield of the earlier planting, the method comprising: a) treating corn seeds with a composition comprising an effective amount of a lipo-chitooligosaccharide (LCO): and b) providing the treated corn seeds to a farmer for growing in a field in which corn was planted in an immediately preceding growing season.

In an aspect, the LCO in a composition is present in an amount from about 8 to about 16 ounce/acre. In an aspect, the LCO is at a concentration of at least about 8 ounce/acre, at least about 9 ounce/acre, at least about 10 ounce/acre, at least about 11 ounce/acre, at least about 12 ounce/acre, at least about 13 ounce/acre, at least about 14 ounce/acre, at least about 15 ounce/acre, or at least about 16 ounce/acre. In an aspect, the LCO is at a concentration from about 8 to about 16 ounce/acre, from about 9 to about 16 ounce/acre, from about 10 to about 16 ounce/acre, from about 11 to about 16 ounce/acre, from about 12 to about 16 ounce/acre, from about 13 to about 16 ounce/acre, from about 14 to about 16 ounce/acre, or from about 15 to about 16 ounce/acre.

In an aspect, the yield of corn grown in the field with the composition is at least 3%, 4%, 5%, 6%, 7%, 8%, 9%, 10%, 11%, 12%, 13%, 14%, or 15%0 higher than the yield of corn grown in a comparable field after one or more consecutive corn plantings without the composition.

In an aspect, the yield of corn grown in the field with the composition is from about 0.5% to about 15%, 1% to about 15%, 2% to about 15%, 3% to about 15%, from about 4% to about 15%, from about 5% to about 15%, from about 6% to about 15%, from about 7% to about 15%, from about 8% to about 15%, from about 9% to about 15%, from about 10% to about 15%, from about 11% to about 15%, from about 12% to about 15%, from about 13% to about 15%, or from about 14% to about 15% higher than the yield of corn grown in a comparable field after one or more consecutive corn plantings without the composition.

In an aspect, the present disclosure includes a method comprising providing to a person a population of corn seeds in need of reducing a corn-on-corn yield penalty and a composition comprising an effective amount of a lipo-chitooligosaccharide (LCO), where the amount is effective for reducing the corn-on-corn yield penalty.

As used herein, the term “a person” is intended to mean a farmer, a farm worker, a laborer, or any other parties similarly situated. In one aspect, a method can be carried out by a person in need thereof.

In yet another aspect, the present disclosure includes a method for growing a population of corn plants, comprising selecting a field in which corn was grown during a growing season that immediately precedes selection of the field, planting corn seeds in need of reducing a corn-on-corn yield penalty that have been treated with an effective amount of a lipo-chitooligosaccharide (LCO) in the selected field, where the amount is effective for reducing the corn-on-corn yield penalty.

As used herein, the term “growing season(s)” is intended to mean a period of time in a given year when the climate is prime for crops to experience the most growth.

As used herein, the terms “first,” “second,” “previous,” “prior,” “earlier,” “later,” or “subsequent” refer to a temporal relationship between two plantings of a population of plants immediately after one another in two consecutive growing seasons without being interrupted by a third planting of a population of plants.

An aspect of the present disclosure includes a method of preventing or reducing a corn-on-corn yield penalty in a population of corn plants in need thereof comprising: a) applying a composition comprising an effective amount of a lipo-chitooligosaccharide (LCO) to corn seeds and/or to a field in which corn was grown during a growing season that immediately precedes planting of the corn seeds: and b) planting the corn seeds in the field without growing a population of non-corn plants in the field prior to planting the corn seeds, where the amount is effective to prevent or reduce the corn-on-corn yield penalty.

In an aspect, the field in which corn was grown during a growing season that immediately precedes planting of the corn seeds did not grow a population of non-corn plants in any of the two growing seasons that immediately preceded planting of the corn seeds. In another aspect, the population of non-corn plants is planted at least 10,000 plants/acre. In an aspect, the field in which corn was grown during a growing season that immediately precedes planting of the corn seeds was not fallow in any of the two or more growing seasons that immediately preceded planting of the corn seeds. In an aspect, the population of non-corn plants are nitrogen-fixing plants. In an aspect, the nitrogen-fixing plants are leguminous plants. In an aspect, the leguminous plants are soybean plants. In an aspect the population of non-corn plants are non-nitrogen-fixing plants. In an aspect, the non-nitrogen-fixing plants are selected from the group consisting of wheat and cotton. In an aspect, the yield of the population of corn plants is equal to or greater than the corn yield of a comparable field without the composition. In a further aspect, the yield of the population of corn plants is equal to or greater than the corn yield of a comparable field without the composition.

As used herein, the term “comparable field” is intended to mean a field in an approximate location to the field applied with the composition, grown in essentially similar soil and weather conditions as the field applied with the composition, and planted with similar corn seeds under the same management (i.e., corn plants were grown the previous growing season) and treatments as the field applied with the composition.

A further aspect of the present disclosure is that the disclosure includes a method of enhancing corn yield in a field grown in a corn-on-corn rotation for two or more consecutive growing seasons, comprising: a) growing a first population of corn plants in the field during a first growing season; and b) growing a second population of corn plants in the field during a second growing season; where the second population of corn plants is treated with a composition comprising a lipo-chitooligosaccharide (LCO) prior to planting, at the time of planting and/or after planting, and where the first and second growing seasons are consecutive growing seasons.

In an aspect, the composition is applied to the corn seeds of the second population of corn plants prior to planting. In an aspect the composition is applied to the soil prior to planting. In an aspect, the composition is applied to the seeds of the second population of corn plants at planting. In an aspect, the composition is applied to the soil after planting. In an aspect, the composition is applied to the foliage of the second population of corn plants. In an aspect the population of non-corn plants are nitrogen-fixing plants. In an aspect, the field was not fallow in the two or more consecutive corn growing seasons. In one aspect, the yield of the second population of corn plants is equal to or more than the yield of the first population of corn plants.

As used herein, the terms “crop rotation” and “rotation” are intended to mean the planting of one or more different crops in the same field in consecutive growing seasons, in contrast to a one-crop system or to haphazard crop successions.

In an aspect, the non-corn plants are nitrogen-fixing plant. In an aspect, the nitrogen-fixing plants are leguminous plants. In an aspect, the leguminous plants are soybean plants. In an aspect, the non-corn plants are non-nitrogen-fixing plant. In an aspect, the non-nitrogen-fixing plants are selected from the group consisting of wheat and cotton.

In an aspect, the method further comprises growing a third corn crop in the field in a third subsequent growing season where the yield of the third population of corn plants is at least equal to the first or second population of corn plants.

In another aspect, the disclosure includes a method of reducing a corn-on-corn yield penalty in a field grown in a corn-on-corn rotation for two or more consecutive growing seasons, comprising: a) growing a first population of corn plants in the field during a first growing season; and b) growing a second population of corn plants in the field during a second growing season; the second population of corn plants is treated with a composition comprising a lipo-chitooligosaccharide prior to planting, at the time of planting and/or after planting, and where the first and second growing seasons are consecutive growing seasons.

An even further aspect of the present disclosure includes a method of crop rotation management that provides for two consecutive corn plantings in a field where the later planting provides a yield that is at least 80%, 82%, 84%, 86%, 88%, 90%, 92%, 94%, 96%, 98%, 100%, 102%, 104%, 106%, 108%, 110%, 115%, 120%, or 125% of the yield of the earlier planting, the method comprising: a) treating corn seeds with a composition comprising an effective amount of a lipo-chitooligosaccharide (LCO); and b) providing the treated corn seeds to a farmer for growing in a field in which corn was planted in an immediately preceding growing season.

Treating can be performed in its entirety by any appropriate entity, including without limitation, a farmer, a farm worker, a laborer, a seed distributor, an agrochemical company, an agricultural technology company, or any other parties similarly situated.

In an aspect, the field has not been intercropped in any one of the previous two, three, four, or five consecutive growing seasons. In an aspect, a population of nitrogen-fixing plants have not been grown in any one of the previous two, three, four, or five consecutive growing seasons. In an aspect, the nitrogen-fixing plants are leguminous plants. In an aspect, the leguminous plants are soybean plants.

The present disclosure further includes a method of reducing a corn-on-corn yield penalty, the method comprising: a) planting a corn seeds in need thereof that have been treated with a composition comprising a lipo-chitooligosaccharide (LCO) in a field in which corn was grown during a growing season that immediately precedes planting of the corn seeds in need thereof; b) growing corn from the corn seeds in need thereof; and c) producing a yield of corn where the corn-on-corn yield penalty is reduced as a result of the composition comprising a lipo-chitooligosaccharide (LCO).

In an aspect, the yield of corn from the corn seeds in need thereof is greater than the yield of corn obtained from the corn field in the prior growing season that immediately precedes planting of the corn seeds in need thereof.

In another aspect, the present disclosure includes a method of reducing the corn-on-corn yield penalty, the method comprising: a) administering, to a population of corn plants, corn seeds and/or soil containing a population of corn plants or corn seeds in need thereof, a composition comprising an effective amount of a lipo-chitooligosaccharide (LCO); and b) growing the population of corn plants or corn seeds in need thereof in the soil; where corn was grown in the soil during a growing season that immediately precedes growth of the population of corn plant or corn seeds.

As used herein, the term “administering” could be performed in its entirety by a farmer, a farm worker, a laborer, a seed distributor, an agrochemical company, an agricultural technology company, or any other parties similarly situated.

In yet another aspect, the present disclosure further includes a method comprising: a) planting corn seeds in soil in which corn was grown during a growing season that immediately precedes planting of the corn seeds; and b) applying a composition comprising a lipo-chitooligosaccharide (LCO) to the soil, to the corn seeds and/or to plants that germinate from the corn seeds, where the composition is capable of increasing the yield of the plants.

In an aspect, no seeds of a non-corn plant were sown in the soil during any one of the previous 1, 2, 3, 4, 5, 6, 7, 8, 9, 10 or more growing seasons. In an aspect, the method further comprises applying one or more compositions selected from the group consisting of one or more agronomically beneficial elements to the soil, one or more agronomically beneficial elements to the seed, one or more agrononmically beneficial elements to the plant that germinates from the seed, one or more lipo-chitooligosaccharides, one or more chitooligosaccharides, one or more chitinous compounds, one or more isoflavonoids, jasmonic acid or derivatives thereof, linolenic acid or derivatives thereof, linoleic acid or derivatives thereof, one or more Karrakins, one or more pesticides, one or more fertilizers, and any combination of the above compositions.

The present disclosure further includes a method of maximizing a field's farming revenue, the method comprising: a) determining a first projected net revenue from consecutive plantings of corn for at least two growing seasons in the field: b) determining a second projected net revenue from a corn on non-corn rotation in the field for the same number of growing seasons; c) determining a third projected net revenue from consecutive plantings of corn for at least two growing seasons in the field, where the third projected net revenue assumes that the corn and/or the field will be treated with a composition capable of reducing a corn-on-corn yield penalty in the field: d) comparing the first, second and third projected net revenues: e) recommending consecutive corn plantings; and f) providing corn seeds that have been treated with a composition comprising an effective amount of a lipo-chitooligosaccharide (LCO).

The present disclosure also includes a method comprising a) providing a farmer in need thereof with instructions for reducing a corn-on-corn yield penalty by applying an effective amount of LCO to a corn seed or to plants growing from the corn seed; and b) providing to the farmer a composition comprising an effective amount of LCO for reducing the corn-on-corn yield penalty.

In one aspect, “providing” can be performed by any person but, without limitation, can be performed in its entirety by a farmer, a farm worker, a laborer, a seed distributor, an agrochemical company, an agricultural technology company, or any other parties similarly situated.

Although the disclosure herein has been described with reference to particular aspects, it is to be understood that these aspects are merely illustrative of the principles and applications of the present disclosure. It is therefore to be understood that numerous modifications may be made to the illustrative aspects and that other arrangements may be devised without departing from the spirit and scope of the present disclosure as defined by the appended claims.

The following are exemplary embodiments of the present disclosure.

### Embodiment 1

A method comprising:
a. applying a composition comprising a lipo-chitooligosaccharide (LCO) to a population of corn plants or corn seeds in need of reducing a corn-on-corn yield penalty; and
b. growing or planting said population of corn plants or corn seeds in need thereof in a field in which corn was grown during a growing season that immediately precedes planting of said population of corn plant or corn seeds in need thereof, wherein said composition is capable of reducing said corn-on-corn yield penalty.

### Embodiment 2

The method of Embodiment 1, wherein said composition further comprises an agronomically acceptable carrier.

### Embodiment 3

The method of Embodiment 1 or 2, wherein said LCO is synthetic.

### Embodiment 4

The method of any one of Embodiments 1 to 3, wherein said LCO is obtained from a microorganism selected from the group consisting of bacteria from the genera Rhizobium, Bradyrhizobium, Sinorhizobium, and Azorhizobium.

### Embodiment 5

The method of any one of Embodiments 1 to 4, wherein said Rhizobium is selected from the group consisting of R. cellulosilyticum, R. daejeonense, R. etli, R. galegae, R. gallicum, R. giardinii, R. hainanense, R. huautlense, R. indigoferae, R. leguminosarum, R. loessense, R. lupini, R. lusitanum, R. meliloti, R. mongolense, R. miluonense, R. sullae, R. tropici, R. undicola and R. yanglingense.

### Embodiment 6

The method of any one of Embodiments 1 to 5, wherein said Bradyrhizobium is selected from the group consisting of B. bete, B. canariense, B. elkantii, B. iriomotense, B. japonicum, B. jicamae, B. liaoningense, B. pachyrhizi, and B. yuanmingense.

### Embodiment 7

The method of any one of Embodiments 1 to 6, wherein said Sinorhizobium is selected from the group consisting of S. abri, S. adhaerens, S. americanum. S. aboris, S. fredii, S. indiaense, S. kostiense, S. kummerowiae, S. medicae, S. melilotti, S. mexicanus, S. morelense, S. saheli, S. terangae, and S. xinjiangense.

### Embodiment 8

The method of any one of Embodiments 1 to 7, wherein said Azorhizobium is selected from the group consisting of A. caulinodans and A. doebereinerae.

### Embodiment 9

The method of any one of Embodiments 1 to 8, wherein said LCO is obtained from a mycorrhizal fungus.

### Embodiment 10

The method of any one of Embodiments 1 to 9, wherein said mycorrhizal fungus is from a strain of Glomerocycota.

### Embodiment 11

The method of any one of Embodiments 1 to 10, wherein said Glomerocycota is Glomus intraradicus.

### Embodiment 12

The method of any one of Embodiments 1 to 11, wherein said LCO is present in an amount from 10⁻⁵ to 10⁻¹⁴ Molar.

### Embodiment 13

The method of any one of Embodiments 1 to 12, wherein said LCO is present in an amount from 1×10¹ to 1×10¹⁵ colony forming units (cfu)/seed.

### Embodiment 14

The method of any one of Embodiments 1 to 13, wherein said LCO is provided in an amount from about 8 to about 16 ounce % acre.

### Embodiment 15

The method of any one of Embodiments 1 to 14, wherein said composition does not include a functional level of a phosphate solubilizing microorganism.

### Embodiment 16

The method of any one of Embodiments 1 to 15, wherein said composition does not include a phosphate solubilizing microorganism from the genus Penicillium.

### Embodiment 17

The method of any one of Embodiments 1 to 16, wherein said 15 composition does not include a detectable level of Penicillium bilaii.

### Embodiment 18

The method of any one of Embodiments 1 to 17, wherein a yield of corn grown in said field with said composition is at least 3%, 4%, 5%, 6%, 7%, 8%, 9%, 10%, 11%, 12%, 13%, 14%, or 15% higher than a yield of corn grown in a comparable field after one or more consecutive corn plantings without said composition.

### Embodiment 19

The method of any one of Embodiments 1 to 18, wherein said applying said composition is selected from the group consisting of coating said corn seeds with said composition prior to planting, applying said composition to soil of said field prior to planting, applying said composition to soil of said field at planting, applying said composition to soil of said field after planting, and applying said composition to foliage of a population of corn plants growing in said field.

### Embodiment 20

The method of any one of Embodiments 1 to 19, wherein said applying is applying said composition in-furrow.

### Embodiment 21

The method of any one of Embodiments 1 to 20, wherein said applying is applying said composition to said corn seeds as a seed coating.

### Embodiment 22

The method of any one of Embodiments 1 to 21, wherein said composition is in a form selected from the group consisting of a wettable powder, a granular powder, a liquid, a peat-based composition, and a seed coating.

### Embodiment 23

The method of any one of Embodiments 1 to 22, wherein said population of corn plants are further treated with a fertilizer.

### Embodiment 24

A method comprising providing to a person a population of corn seeds in need of reducing a corn-on-corn yield penalty and a composition comprising an effective amount of a lipo-chitooligosaccharide (LCO), wherein said amount is effective for reducing said corn-on-corn yield penalty.

### Embodiment 25

The method of Embodiment 24, wherein said composition is applied to said corn seeds prior to said providing.

### Embodiment 26

The method of Embodiment 24 or 25, wherein said composition is applied to said corn seeds prior to planting.

### Embodiment 27

The method of any one of Embodiments 24 to 26, wherein said composition is applied to soil in which said population of corn seeds is growing prior to planting.

### Embodiment 28

The method of any one of Embodiments 24 to 27, wherein said composition is applied to said corn seeds at planting.

### Embodiment 29

The method of any one of Embodiments 24 to 28, wherein said composition is applied to soil in which said population of corn seeds is growing prior to development stage V1.

### Embodiment 30

The method of any one of Embodiments 24 to 29, wherein said composition is applied to foliage of corn plants germinating from said corn seeds prior to development stage V1.

### Embodiment 31

The method of any one of Embodiments 24 to 30, wherein a field in which said population of corn seeds is growing is greater than 100 square meters.

### Embodiment 32

A method for growing a population of corn plants, comprising selecting a field in which corn was grown during a growing season that immediately precedes selection of said field, planting corn seeds in need of reducing a corn-on-corn yield penalty treated with an effective amount of a lipo-chitooligosaccharide (LCO) in said selected field, wherein said amount is effective for reducing said corn-on-corn yield penalty.

### Embodiment 33

The method of Embodiment 32, wherein said composition further comprises an agronomically acceptable carrier.

### Embodiment 34

The method of Embodiment 32 or 33, wherein said LCO is obtained from a microorganism selected from the group consisting of bacteria from the genera Rhizobium, Bradyrhizobium, Sinorhizobium, and Azorhizobium.

### Embodiment 35

The method of any one of Embodiments 32 to 34, wherein said composition further comprises a microorganism, a pesticide, or a combination of microorganism and pesticide.

### Embodiment 36

The method of any one of Embodiments 32 to 35, wherein said pesticide is selected from the group consisting of an insecticide, a fungicide, a nematicide, and combinations thereof.

### Embodiment 37

The method of any one of Embodiments 32 to 36, wherein said treating with said Penicillium bilaii is selected from the group consisting of coating said corn seeds prior to planting, applying to soil of said field prior to planting, applying to soil of said field at planting, applying to soil of said field after planting, and applying to foliage of a population of corn plants growing in said field.

### Embodiment 38

A method of preventing a corn-on-corn yield penalty in a population of corn plants in need thereof comprising:
a. applying a composition comprising an effective amount of a lipo-chitooligosaccharide (LCO) to corn seeds and/or to a field in which corn was grown during a growing season that immediately precedes planting of said corn seeds; and
b. planting said corn seeds in said field without growing a population of non-corn plants in said field prior to planting said corn seeds, wherein said amount is effective to prevent said corn-on-corn yield penalty.

### Embodiment 39

A method of reducing a corn-on-corn yield penalty in a population of corn plants in need thereof comprising:
a. applying a composition comprising an effective amount of a lipo-chitooligosaccharide (LCO) to corn seeds and/or to a field in which corn was grown during a growing season that immediately precedes planting of said corn seeds; and
b. planting said corn seeds in said field without growing a population of non-corn plants in said field prior to planting said corn seeds, wherein said amount is effective to reduce said corn-on-corn yield penalty.

### Embodiment 40

The method of Embodiment 38, wherein said field in which corn was grown during a growing season that immediately precedes planting of said corn seeds did not grow a population of non-corn plants in any of the two growing seasons that immediately preceded planting of said corn seeds.

### Embodiment 41

The method of Embodiment 39, wherein said field in which corn was grown during a growing season that immediately precedes planting of said corn seeds did not grow a population of non-corn plants in any of the two growing seasons that immediately preceded planting of said corn seeds.

### Embodiment 42

The method of Embodiment 38 or 40, wherein said field in which corn was grown during a growing season that immediately precedes planting of said corn seeds was not fallow in any of the two growing seasons that immediately preceded planting of said corn seeds.

### Embodiment 43

The method of Embodiment 39 or 41, wherein said field in which corn was grown during a growing season that immediately precedes planting of said corn seeds was not fallow in any of the two growing seasons that immediately preceded planting of said corn seeds.

### Embodiment 44

The method of Embodiment 38, 40, or 42 wherein said population of non-corn plants are nitrogen-fixing plants.

### Embodiment 45

The method of Embodiment 38, 40, 42, or 44, wherein said nitrogen-fixing plants are leguminous plants.

### Embodiment 46

The method of Embodiment 38, 40, 42, 44, or 45, wherein said leguminous plants are soybean plants.

### Embodiment 47

The method of any one of Embodiments 38, 40, 42, and 44 to 46, wherein said population of non-corn plants are non-nitrogen-fixing plants.

### Embodiment 48

The method of any one of Embodiments 38, 40, 42, and 44 to 47, wherein said non-nitrogen-fixing plants are selected from the group consisting of wheat and cotton.

### Embodiment 49

The method of any one of Embodiments 38, 40, 42, and 44 to 48, wherein a yield of said population of corn plants is equal to or greater than a corn yield of a comparable field without said composition.

### Embodiment 50

The method of Embodiment 39, 41, or 42, wherein a yield of said population of corn plants is equal to or greater than a corn yield of a comparable field without said composition.

### Embodiment 51

A method of enhancing corn yield in a field grown in a corn-on-corn rotation for two or more consecutive growing seasons, comprising:
a. growing a first population of corn plants in said field during a first growing season; and
b. growing a second population of corn plants in said field during a second growing season; wherein said second population of corn plants is treated with a composition comprising a lipo-chitooligosaccharide (LCO) prior to planting, at the time of planting and/or after planting, and wherein said first and second growing seasons are consecutive growing seasons.

### Embodiment 52

The method of Embodiment 51, wherein said composition is applied to seeds of said second population of corn plants prior to planting.

### Embodiment 53

The method of Embodiment 51 or 52, wherein said composition is applied to soil of said field prior to planting.

### Embodiment 54

The method of any one of Embodiments 51 to 53, wherein said composition is applied to seeds of said second population of corn plants at planting.

### Embodiment 55

The method of any one of Embodiments 51 to 54, wherein said composition is applied to soil of said field after planting.

### Embodiment 56

The method of any one of Embodiments 51 to 55, wherein said composition is applied to foliage of said second population of corn plants.

### Embodiment 57

The method of any one of Embodiments 51 to 56, wherein a yield of said second population of corn plants is equal to or more than a yield of said first population of corn plants.

### Embodiment 58

A method of reducing a corn-on-corn yield penalty in a field grown in a corn-on-corn rotation for two or more consecutive growing seasons, comprising:
a. growing a first population of corn plants in said field during a first growing season; and
b. growing a second population of corn plants in said field during a second growing season; said second population of corn plants is treated with a composition comprising a lipo-chitooligosaccharide prior to planting, at the time of planting and/or after planting, and wherein said first and second growing seasons are consecutive growing seasons.

### Embodiment 59

The method of Embodiment 58, wherein said composition is applied to seeds of said second population of corn plants prior to planting.

### Embodiment 60

The method of Embodiment 58 or 59, wherein said composition is applied to soil of said field prior to planting.

### Embodiment 61

The method of any one of Embodiments 58 to 60, wherein said composition is applied to seeds of said second population of corn plants at planting.

### Embodiment 62

The method of any one of Embodiments 58 to 61, wherein said composition is applied to soil of said field after planting.

### Embodiment 63

The method of any one of Embodiments 58 to 62, wherein said composition is applied to foliage of said population of corn plants.

### Embodiment 64

The method of any one of Embodiments 58 to 63, wherein a yield of said second population of corn plants is equal to or more than a yield of said first population of corn plants.

### Embodiment 65

The method of any one of Embodiments 51 to 57, wherein said field was not fallow in said two or more consecutive corn growing seasons.

### Embodiment 66

The method of any one of Embodiments 51 to 57 and 65, further comprising growing a third population of corn plants in said field in a third subsequent growing season wherein a yield of said third population of corn plants is at least equal to a yield of said first or said second populations of corn plants.

### Embodiment 67

The method of any one of Embodiments 58 to 64, further comprising growing a third population of corn plants in said field in a third subsequent growing season wherein a yield of said third population of corn plants is at least equal to a yield of said first or said second populations of corn plants.

### Embodiment 68

A method of crop rotation management that provides for two consecutive corn plantings in a field where the later planting provides a yield that is at least 80%, 82%, 84%, 86%, 88%, 90%, 92%, 94%, 96%, 98%, 100%, 102%, 104%, 106%, 108%, 110%, 115%, 120%, or 125% of the yield of the earlier planting, said method comprising:
a. treating corn seeds with a composition comprising an effective amount of a lipo-chitooligosaccharide (LCO); and
b. providing said treated corn seeds to a farmer for growing in a field in which corn was planted in an immediately preceding grossing season.

### Embodiment 69

The method of Embodiment 68, wherein said field is not intercropped in any one of the previous two, three, four, or five consecutive growing seasons.

### Embodiment 70

The method of Embodiment 68 or 69, wherein a population of nitrogen-fixing plants is not grown in any one of the previous two, three, four, or five consecutive growing seasons.

### Embodiment 71

The method of any one of Embodiments 68 to 70, wherein a population of nitrogen-fixing plants is not grown in the previous two consecutive growing seasons.

### Embodiment 72

The method of any one of Embodiments 68 to 71, wherein a population of nitrogen-fixing plants is not grown in the previous three consecutive growing seasons.

### Embodiment 73

The method of any one of Embodiments 68 to 72, wherein a population of nitrogen-fixing plants is not grown in the previous four consecutive growing seasons.

### Embodiment 74

The method of any one of Embodiments 68 to 73, wherein a population of nitrogen-fixing plants is not grown in the previous five consecutive growing seasons.

### Embodiment 75

The method of any one of Embodiments 68 to 74, wherein said nitrogen-fixing plants are leguminous plants.

### Embodiment 76

The method of Embodiment 75, wherein said leguminous plants are soybean plants.

### Embodiment 77

A method of reducing a corn-on-corn yield penalty, said method comprising:
a. planting a corn seeds in need thereof that have been treated with a composition comprising a lipo-chitooligosaccharide (LCO) in a field in which corn was grown during a growing season that immediately precedes planting of said corn seeds in need thereof;
b. growing corn from said corn seeds in need thereof; and
c. producing a yield of corn wherein said corn-on-corn yield penalty is reduced as a result of said composition comprising a lipo-chitooligosaccharide (LCO).

### Embodiment 78

The method of Embodiment 77, wherein a yield of corn from said corn seeds in need thereof is greater than a yield of corn obtained from said field in the prior growing season that immediately precedes planting of said corn seeds in need thereof.

### Embodiment 79

A method of reducing the corn-on-corn yield penalty, said method comprising:
a. administering, to a population of corn plants, corn seeds and/or soil containing a population of corn plants or corn seeds in need thereof, a composition comprising an effective amount of a lipo-chitooligosaccharide (LCO); and
b. growing said population of corn plants or corn seeds in need thereof in said soil; wherein corn was grown in said soil during a growing season that immediately precedes growth of said population of corn plant or corn seeds.

### Embodiment 80

A method comprising:
a. planting corn seeds in soil in which corn was grown during a growing season that immediately precedes planting of said corn seeds; and
b. applying a composition comprising a lipo-chitooligosaccharide (LCO) to said soil, to said corn seeds and/or to plants that germinate from said corn seeds, wherein said composition is capable of increasing a yield of said plants.

### Embodiment 81

The method of Embodiment 80, wherein said composition is applied to said corn seeds prior to planting.

### Embodiment 82

The method of Embodiment 80 or 81, wherein said applying is at least 0.25, 0.5, 0.75, 1, 2, 3, 4, 5, 6, 7, 8, 9, 10, 11, 12, 15, 18, 21, 24, 27, 30, 33, 36 months or more prior to planting.

### Embodiment 83

The method of any one of Embodiments 80 to 82, wherein said composition is applied to said soil prior to planting.

### Embodiment 84

The method of any one of Embodiments 80 to 83, wherein said composition is applied to said soil at planting.

### Embodiment 85

The method of any one of Embodiments 80 to 84, wherein said composition is applied to said soil after planting.

### Embodiment 86

The method of any one of Embodiments 80 to 85, wherein said composition is applied to foliage of said plants that germinate from said corn seeds.

### Embodiment 87

The method of any one of Embodiments 80 to 86, wherein corn was sown in said soil for at least the previous two or more consecutive growing seasons.

### Embodiment 88

The method of Embodiment 87, wherein said at least the previous two or more growing seasons is the previous three, four, five, six, seven, eight, nine, ten, or more growing seasons.

### Embodiment 89

The method of Embodiment 87 or 88, wherein said method is capable of reducing the corn-on-corn yield penalty from consecutive corn planting by at least about 1, 2, 3, 4, 5, 10, 15, 20, 25, 30, 35, 40, 45, 50, 55, 60, 65, 70, 75, 80, 85, 90, 95%, or more.

### Embodiment 90

The method of any one of Embodiments 80 to 87, wherein a corn-on-corn yield penalty is less than 20, 21, 22, 23, 23, 24, 25, 26, 27, 28, 29, 30, 35, 40, 45, or 50 bushels/acre.

### Embodiment 91

The method of any one of Embodiments 80-90, wherein one or more characteristics of plant growth such as plant height, plant weight, number of cobs, cob weight, kernel number, kernel weight, and date to maturity, are enhanced by at least 1, 2, 3, 4, 5, 10, 15, 20, 25, 30, 35, 40, 45, 50, 55, 60, 65, 70, 75, 80, 85, 90, 95, 100, 125, 150, 175, 200, 250, 300%, or more.

### Embodiment 92

The method of any one of Embodiments 80 to 87, wherein said yield from said corn seeds is enhanced by at least 5, 10, 15, 20, 25, 30, 35, 40, 45, 50, 55, 60, 65, 70, 75, 80, 85, 90, 95, 100, 125, 150, 175, 200, 250, 300%, or more in relative to a corn yield from said previous growing season.

### Embodiment 93

The method of any one of Embodiments 80 to 87, wherein no seeds of a population of non-corn plants were sown in said soil during any one of the previous 1, 2, 3, 4, 5, 6, 7, 8, 9, 10, or more growing seasons.

### Embodiment 94

A method of maximizing a field's farming revenue, said method comprising:
a determining a first projected net revenue from consecutive plantings of corn for at least two growing seasons in said field;
b. determining a second projected net revenue from a corn on non-corn rotation in said field for the same number of growing seasons;
c. determining a third projected net revenue from consecutive plantings of corn for at least two growing seasons in said field, wherein said third projected net revenue assumes that said corn and/or said field will be treated with a composition capable of reducing a corn-on-corn yield penalty in said field;
d. comparing said first, second and third projected net revenues;
e. recommending consecutive corn plantings; and
f. providing corn seeds that have been treated with a composition comprising an effective amount of a lipo-chitooligosaccharide (LCO).

### Embodiment 95

The method of Embodiments 1, 24, 32, 38, 39, 51, 58, 68, 77, 79, 80, and 94, further comprising applying one or more compositions selected from the group consisting of one or more agronomically beneficial elements to the soil, one or more agronomically beneficial elements to the seed, one or more agronomically beneficial elements to the plant that germinates from the seed, one or more lipo-chitooligosaccharides (LCO), one or more chitooligosaccharides, one or more chitinous compounds, one or more isoflavonoids, jasmonic acid or derivatives thereof, linolenic acid or derivatives thereof, linoleic acid or derivatives thereof, one or more karrakins, one or more pesticides, one or more fertilizers, and any combination of the above compositions.

### Embodiment 96

The method of Embodiment 95, further comprising a microbe selected from the group consisting of the genera Rhizobium spp., Acinetobacter. Arthrobacter, Arthrobotrys, Aspergillus, Azospirllium, Bacillus, Burkholderia, chryseomonas, Enterobacter, Eupenicillium, Exiguobacterium, Klebsiella, Kluyvera, Microbacterium, Mucor, Paecilomyces, Paenibacillus, Penicillium, Pseudomonas, Serratia, Stenotrophomonas, Streptomyces, Streptosporangium, Swaminathania, Thiobacillus, Torulospora, Vibrio, Xanthobacter, and Xanthomonas.

### Embodiment 97

A method comprising:
a. providing a farmer in need thereof with instructions for reducing a corn-on-corn yield penalty by applying an effective amount of LCO to a corn seed or to plants growing from said corn seed: and
b. providing to said farmer a composition comprising an effective amount of LCO for reducing said corn-on-corn yield penalty.

### Embodiment 98

The method of Embodiment 95 or 96, further comprising an isoflavonoid or isoflavone.

### Embodiment 99

The method of Embodiment 95, 96 or 98, further comprising a pesticide selected from the group consisting of a fungicide, insecticide, or nematicide.

### Embodiment 100

The method of any one of Embodiments 1 to 22, wherein said composition further comprises a microorganism, a pesticide, or a combination of microorganism and pesticide.

### Embodiment 101

The method of Embodiment 100, wherein said microorganism is selected from the group consisting of bacteria from the genera Rhizobium, Bradyrhizobium, Azorhizobium, Sinorhizobium, Mesorhizobium, and combinations thereof.

### Embodiment 102

The method of Embodiment 100 or 101, wherein said microorganism is applied at a rate of about 1×10², 5×10², 1×10³, 5×10³, 1×10⁴, 5×10⁴, 1×10⁵, 5×10⁵, 1×10⁶, 5×10⁶, 1×10⁷, 5×10⁷, or 1×10⁸ colony forming units per seed

### Embodiment 103

The method of Embodiment 101, wherein said Rhizobium is selected from the group consisting of R. cellulosilyticum, R. daejeonense, R. etli, R. galegae, R. gallicum, R. giardinii, R. hainanense, R. huautlense, R. indigoferae, R. leguminosarum, R. loessense, R. lupini, R. lusitanum, R. meliloti, R. mongolense, R. miluonense, R. sullae, R. iropici, R. undicola, and R. yanglingense.

### Embodiment 104

The method of Embodiment 101, wherein said Bradyrhizobium is selected from the group consisting of B. bete, B. canariense, B. elkanii, B. trtomotense, B. japonicium, B. jicamae, B. liaoningense, B. pachyrhizi, and B. yuanmingense.

### Embodiment 105

The method of Embodiment 101, wherein said Azorhizobium is selected from the group consisting of A. caulinodans and A. doebereinerae.

### Embodiment 106

The method of Embodiment 101, wherein said Sinorhizobium is selected from the group consisting of S. abri, S. adhaerens, S. americanum, S. aboris, S. fredii, S. indiaense, S. kostiense, S. kummerowiae, S. medicae, S. meliloti, S. mexicanus, S. morelense, S. saheli. S. terangae, and S. xinjiangense.

### Embodiment 107

The method of Embodiment 101, wherein said Mesorhizobium is selected from the group consisting of M. albiziae, M. amorphae, M. chacoense, M. ciceri, M. huakuii, M. loti, M. mediterraneum, M. pluifarium, M. septentrionale, M. temperatum, and M. tianshanense.

### Embodiment 108

The method of any one of Embodiments 100 to 107, wherein said pesticide is selected from the group consisting of an insecticide, a fungicide, a nematicide, and combinations thereof.

### Embodiment 109

The method of Embodiment 108, wherein said fungicide is selected from the group consisting of pyraclostrobin, propiconazole, trifloxystrobin, azoxystrobin, fluxapyroxad, and combinations thereof.

### Embodiment 110

The method of any one of Embodiments 1 to 22, wherein said corn seeds are treated with a composition selected from the group consisting of cyantraniliprole, thiamethoxam, clothianidin, imidacloprid, sedaxane, azoxystrobin, fludioxonil, metalaxyl, mefenoxam, thiabenzole, prothioconazole, fluoxastrobin, fluxapyroxad, fluopyram, pyraclostrobin, Votivo, a second LCO, Penicllium bilaii. Bradyrhizobium japonicum, and combinations thereof.

### Embodiment 111

The method of any one of Embodiments 1 to 22 and 110, wherein said population of corn plants is further treated with a composition selected from the group consisting of a fungicide, herbicide, insecticide, acaricide, nematicide, and a combination thereof.

### Embodiment 112

The method of any one of Embodiments 1 to 22, 110, and 111, wherein said fungicide is selected from the group consisting of pyraclostrobin, propiconazole, trifloxystrobin, azoxystrobin, fluxapyroxad, and combinations thereof.

### EXAMPLES

### Example 1

It is well documented that planting continuous corn (corn after corn in consecutive planting seasons (non-rotated crops)) demonstrates an increasing yield penalty from year to year. For example, the study reported in Gentry et al., Agron. J., 105(2): 295-303 (2013) as shown in FIG. 1, correlates corn-on-corn yield penalty with the number of years in continuous corn planting, and shows that corn-on-corn yield penalty continues to increase with each year of continuously planting of corn.

### Example 2

Three fields are established (F1, F2, and F3), with F1 for consecutive corn-on-corn planting (CC), F2 for CC provided with an effective amount of composition comprising a lipo-chitooligosaccharide (LCO), and F3 for corn-on-soybean planting (CS). The crops are cultivated in two consecutive growing seasons (GS1 and GS2).

F1, F2, and F3 are managed with standard agronomic practices.

For yield determination at physiological maturity, plots are harvested utilizing standard research equipment. The CC yield penalty (CCYP) in a given growing season is calculated by subtracting the yield for CC from that for CS:

CCYP=Y^{CS}−Y_{CC}

The following table summarizes the study:

| | Crop | | | LCO in | | |
|---|---|---|---|---|---|---|
| Field | planting | GS1 | GS2 | GS2 | Yield at GS2 | CCYP |
| F1 | CC | Corn | Corn | − | Y_{CC} | Y_{CS} − Y_{CC} |
| F2 | CC | Corn | Corn | + | Y_{CC(LCO)} | Y_{CS} − Y_{CC(LCO)} |
| | (LCO) | | | | | |
| F3 | CS | Soy- | Corn | − | Ycs | N/A |
| | | bean | | | | |
| F4 | CS | Soy- | Corn | + | Y_{CS(LCO)} | N/A |
| | (LCO) | bean | | | | |

At GS2, the CC corn yield when provided with an effective amount of LCO is greater than the CC corn yield with no LCO provided (i.e., Y_{CC(LCO)}>Y_{CC}). As a result, the CCYP in a CC planting is reduced when an effective amount of LCO is provided relative to a CC planting with no LCO provided (i.e., (Ycs−Ycc_{(LCO)})<(Ycs−Ycc)).

Y_{CC(LCO)} is at least 100%, 102%, 104%, 106%, 108%, 110%, 115%, 120%, or 125% of Y_{CC}.

In addition, at GS2, the CS corn yield when provided with an effective amount of LCO is greater than the CS corn yield with no LCO provided (i.e., Y_{CS(LCO)}>Y_{CS}).

Further, at GS2, the CS corn yield when provided with an effective amount of LCO is greater than the CC corn yield when provided with an effective amount of LCO (i.e., Y_{CS(LCO)}>Y_{CC(LCO)}).

### Example 3

A lipo-chitooligosaccharide containing product was applied to corn seeds with a commercial fungicide and insecticide base seed treatment (“F/I”) at an application rate of 6.0 oz per 100 pounds of corn seed. The control treatment used for comparison in each trial was the base fungicide and insecticide treated corn seed of the same hybrid represented in the LCO treatment. Field trials with a plot size of 4 rows by 100 ft long were conducted during 2013 at each of the 71 locations utilizing standard research methods and equipment. Some of these locations were planted to corn the previous growing season and were considered corn-on-corn rotation sites while other locations were planted to soybean the previous growing season and were considered soy-on-corn rotation sites. The experimental design was a Randomized Complete Block Design (RCBD) with four replications at each site. Corn yield data was analyzed post-harvest utilizing best linear unbiased estimation (BLUE) linear mixed model and the average yield was calculated for F/I only and F/I plus LCO treated seeds. Significance was determined by calculating p-values for F/I and F/I plus LCO treated conditions.

When averaged across all 71 locations, the F/I plus LCO treatment resulted in a positive yield delta over the F/1 only control of 3.07 bu/A (p value=0.06). When only the corn-on-corn rotations locations were considered, the F/I plus LCO treatment resulted in a positive yield delta over the F/I only control of 6.63 bu/A (p value=0.005), which was a surprising result of significantly reducing the expected corn-on-corn yield penalty in the non-rotated corn fields.

Therefore, the results showed that the corn yield when provided with LCO was greater than the corn yield with no LCO. As a result, the corn-on-corn yield penalty in the corn-on-corn planting was reduced when LCO was provided relative to a corn-on-corn planting without adding LCO.

1. A method comprising:
a. applying a composition comprising a lipo-chitooligosaccharide (LCO) to a population of corn plants, corn seeds, soil, or a combination thereof, in need of reduction of a corn-on-corn yield penalty; and
b. growing or planting said population in need thereof in a field, wherein said population is grown in said field in a growing season immediately following at least one planting of corn plants.

2. The method of claim 1, wherein said composition further comprises an agronomically acceptable carrier.

3. The method of claim 1, wherein said LCO is present in an amount from 1 to 400 grams/hundred weight (g/cwt) seed.

4. The method of claim 1, wherein said LCO is provided in an amount from about 8 to about 16 ounces/acre.

5. The method of claim 1, wherein said composition does not include a functional level of a phosphate solubilizing microorganism.

6. The method of claim 1, wherein,
a) the yield of corn grown in said field with said composition is at least 3% more than a yield of corn grown in a comparable field after one or more consecutive corn plantings without said composition, or
b) where said corn-on-corn yield penalty is less than 50 bushels/acre.

7. The method of claim 6, wherein said applying said composition is selected from the group consisting of:
coating said corn seeds with said composition prior to planting,
applying said composition to soil of said field prior to planting,
applying said composition to soil of said field at planting,
applying said composition to soil of said field after planting,
applying said composition to soil in which said population of corn seeds is growing prior to development stage V1,
applying said composition to foliage of a population of corn plants growing in said field prior to development stage V1,
applying said composition to foliage of a population of corn plants growing in said field, and
any combination thereof.

8. The method of claim 7, wherein said population of corn plants are further treated with a fertilizer.

9. The method of claim 1, wherein said method further comprises applying one or more compositions selected from the group consisting of:
one or more agronomically beneficial elements to said soil,
one or more agronomically beneficial elements to said seed,
one or more agronomically beneficial elements to the plant that germinates from said seed,
one or more chitooligosaccharides,
one or more chitinous compounds,
one or more isoflavonoids,
jasmonic acid or a derivative thereof,
linolenic acid or a derivative thereof,
linoleic acid or a derivative thereof,
one or more karrakins,
one or more pesticides,
one or more fertilizers, and
any combination of the above compositions.

10. The method of claim 1, wherein said composition further comprises a microbe selected from the group consisting of the genera Rhizobium, Acinetobacter, Arthrobacter, Arthrobotrys, Aspergillus, Azospirillum, Bacillus, Burkholderia, chryseomonas, Enterobacter, Eupenicillium, Exiguobacterium, Klebsiella, Kluyvera, Microbacterium, Mucor, Paecilomyces, Paenibacillus, Penicillium, Pseudomonas, Serratia, Stenotrophomonas, Streptomyces, Streptosporangium, Swaminathania, Thiobacillus, Torulospora, Vibrio, Xanthobacter, and Xanthomonas.

11. The method of claim 10, wherein said composition further comprises at least 100 cfu per seed of said microbe, a pesticide, or a combination thereof.

12. The method of claim 11, wherein said microbe is selected from the group consisting of:
bacteria from the genera Rhizobium selected from the group consisting of R. cellulosilyticum, R. daejeonense, R. etli, R. galegae, R. gallicum, R. giardinii, R. hainanense, R. huautlense, R. indigoferae, R. leguminosarum, R. loessense, R. lupini, R. lusitanum, R. meliloti, R. mongolense, R. miluonense, R. sullae, R. tropici, R. undicola, and R. yanglingense;
bacteria from the genera Bradyrhizobium selected from the group consisting of B. bete, B. canariense, B. elkanii, B. iriomotense, B. japonicum, B. jicamae, B. liaoningense, B. pachyrhizi, and B. yuanmingense;
bacteria from the genera Azorhizobium selected from the group consisting of A. caulinodans and A. doebereinerae;
bacteria from the genera Sinorhizobium selected from the group consisting of S. abri, S. adhaerens, S. americanum, S. aboris, S. fredii, S. indiaense, S. kostiense, S. kummerowiae, S. medicae, S. meliloti, S. mexicanus, S. morelense, S. saheli, S. terangae, and S. xinjiangense;
bacteria from the genera Mesorhizobium selected from the group consisting of M. albiziae, M. amorphae, M. chacoense, M. ciceri, M. huakuii, M. loti, M. mediterraneum, M. pluifarium, M. septentrionale, M. temperatum, and M. tianshanense; and
any combinations thereof.

13. The method of claim 1, wherein said population of corn seeds is further treated with a composition selected from the group consisting of cyantraniliprole, thiamethoxam, clothianidin, imidacloprid, sedaxane, azoxystrobin, fludioxonil, metalaxyl, mefenoxam, thiabenzole, prothioconazole, fluoxastrobin, fluxapyroxad, fluopyram, pyraclostrobin, Bacillus firmus, a second LCO, Penicillium bilaii, Bradyrhizobium japonicum, and combinations thereof.

14. The method of claim 1, wherein said population of corn plants is further treated with a composition selected from the group consisting of a fungicide, herbicide, insecticide, acaricide, nematicide, and a combination thereof.

15. The method of claim 1, wherein said field is not intercropped in any one of the previous two growing seasons.

16. The method of claim 1, wherein said field is not intercropped in any one of the previous three growing seasons.

17. The method of claim 1, wherein said field is not intercropped in any one of the previous four growing seasons.

18. The method of claim 1, wherein said field is not intercropped in any one of the previous five growing seasons.

19. The method of claim 1, wherein one or more characteristics of plant growth comprising plant height, plant weight, number of cobs, cob weight, kernel number, kernel weight, and date to maturity, are enhanced by at least 1%.

20. The method of claim 5, wherein said composition does not include a detectable level of Penicillium bilaii.
